(19) United States
(12) Patent Application Publication
(10) Pub. No.: US 2024/0357214 A1
(43) Pub. Date: Oct. 24, 2024

(54) MULTI-DEVICE AND MULTI-USER PERSONALIZED AND INTERACTIVE AUDIO THROUGH SOCIAL MEDIA METADATA

(71) Applicant: Fraunhofer-Gesellschaft zur Förderung der angewandten Forschung e.V., München (DE)

(72) Inventors: Harald FUCHS, Erlangen (DE); Adrian MURTAZA, Erlangen (DE); Stefan MELTZER, Erlangen (DE); Bernd CZELHAN, Erlangen (DE); Ulli SCUDA, Erlangen (DE); Matthias ROSE, Erlangen (DE); Yannik GREWE, Erlangen (DE); Nicolas FAECKS, Erlangen (DE); Johannes SCHMIDL, Erlangen (DE)

(73) Assignee: Fraunhofer-Gesellschaft zur Förderung der angewandten Forschung e.V., München (DE)

(21) Appl. No.: 18/759,797

(22) Filed: Jun. 28, 2024

Related U.S. Application Data
(63) Continuation of application No. PCT/EP2022/088096, filed on Dec. 30, 2022.

(30) Foreign Application Priority Data
Dec. 30, 2021 (EP) 21218386.7

(51) Int. Cl. H04N 21/84; H04N 21/858

(52) U.S. Cl. CPC H04N 21/84; H04N 21/858

(57) ABSTRACT

There are disclosed techniques for performing personalization in a social media environment. E.g., there are disclosed techniques for multi-device and multi-user personalized and interactive audio for example through social media metadata. In one example, there is defined a streaming client device, comprising: a communication interface, to receive, from a streaming server system and/or from another streaming client device, at least one media stream and personalization option metadata enabling personalization options for rendering the at least one media stream according to the personalization options; a metadata engine, to generate personalization settings addressing the personalization options, wherein the communication interface is configured to transmit, to the streaming server system and/or to at least one second streaming client device, and/or to store, personalization metadata describing personalization settings of the at least one media stream.

### CROSS-REFERENCES TO RELATED APPLICATIONS

This application is a continuation of copending International Application No. PCT/EP2022/088096, filed Dec. 30, 2022, which is incorporated herein by reference in its entirety, and additionally claims priority from European Application No. EP 21 218 386.7, filed Dec. 30, 2021, which is incorporated herein by reference in its entirety.

### BACKGROUND OF THE INVENTION

There are disclosed techniques for performing personalization in a social media environment. E.g., there are disclosed techniques (e.g. implemented in a streaming client device, in a streaming server system, in a method, etc.) for multi-device and multi-user personalized and interactive media, e.g. audio, for example through social media metadata.

The present document describes a solution for efficient methods to personalize media and share the personalization e.g. in a social media environment. Personalized social metadata messages are defined for an efficient exchange of personalization information. An aim of this metadata is to share personalization of media playback, especially of next generation audio, e.g. between several media devices and interactivity servers. This enables a connected, personalized media consumption experience for several users. Interactivity servers control the handling of the social media messages and their relationship to content media assets. Content providers can control the personalization for every content asset and can add the connected, social personalization service to their media infrastructure. Alternatively, social media platforms can offer a connected, social personalization service independent of the media service.

The invention also refers, in examples, to Multi-device and Multi-user Personalized and Interactive Audio through Social Media Metadata.

Next Generation Video and Audio systems enable various personalization and content-based interactivity features. MPEG-H Audio is one of the Next-Generation Audio (NGA) systems which offers such advanced personalization options through metadata available in the audio stream. This enables better accessibility to content, for instance through Dialogue Enhancement or Audio Description or adaptation of the content to personal preferences. This is usually done through a selection between different content versions, including options for fine tuning those selections. Personalization can be enabled in the playback devices (e.g., TV set, mobile device etc.). These features can be selected either by a user selection of all options available in the stream or automatically applied based on settings stored on the device.

Similar interactivity options (e.g. personalization options) can be implemented for other media types and media systems (e.g., video delivery) that make use of dedicated metadata present in the media stream for enabling such advanced personalization options. In the following, the description of conventional technology, use cases and the invention will focus on NGA systems, without limiting the application to audio systems.

### PRIOR ART

### Metadata-Driven Personalization in NGA

Personalization and user interactivity in the end user device is controlled through metadata that is part of a bitstream in Next-Generation Audio (NGA) systems such as MPEG-H Audio. This metadata is generated in an “audio scene” authoring step during content production and describes what kind of modifications are possible during audio playback. MPEG-H Audio and other NGA systems define a sophisticated metadata model that enables authoring of very complex and rich audio scenes that can lead to a high number of variations and personalization combinations during playback in the end user device.

Based on the metadata in the bitstream the playback device can setup a user interface to present all options to the user. During playback the end users can then select “on demand” from those options and adapt the audio to their personal preferences. Each change request of the user creates an event that describes those changes. MPEG-H Audio, for example, defines and standardizes those events as metadata bitstream packets (“user interaction packets”) that can be inserted into the bitstream. The decoder adapts those changes during decoding and modifies the audio rendering accordingly. This mechanism allows to detach the user interface from decoding, either into independent functional units within a device, or even into separate, connected devices. Other NGA systems connect the user interface directly to the decoder so that the change requests from the user are immediately applied to the audio output during decoding and rendering of the audio signal.

The end user device that implements the user interface can store the current state of the personalization settings in case the user temporarily pauses the playback, or if the content is temporarily interrupted with other content, e.g. in an advertisement break, and restores the settings after that break. This function of the end user device is sometimes called persistency manager and can be seen as part of the User Interface (UI) manager functional block 820. The end user device can also automatically select personalization settings and thus automatically generate events that are the best matches to generic preferences settings that the user configured in the device settings (for example a preferred language).

### Social Media Sharing of Personalized Content

Social media platforms as they exist today enable users to share and personalize content, for instance images or videos. Users can download content files, modify them (e.g. apply filters to them) and upload them again to share them with friends or a community. Other users can then access this content through the social media platform to consume it or subsequently use it as starting point for further personalization. This is highly inefficient in the sense that each user has to personalize a piece of content which is then send for example to a server and then accessed by other users. Each user is this way able to create its own version of the same content and potentially an extremely large number of content versions have to be stored and delivered over the network constantly. Obviously this requires high storage space and network bandwidth for enabling users to share their personalized content. Additionally, currently this sharing option is limited to one user publishing its version of the content, without the option of other users personalizing the content simultaneously and all users receiving the same joint experience.

### Non-Destructive Modification of Content

Content creation applications, for instance image processing applications, typically keep all processing steps internally as “commands” that are applied “on the fly” during rendering for preview or monitoring, i.e. the processing steps are not immediately applied to the content asset itself. The original content asset stays untouched during the production and content creation process. Only at the end of the process, all modifications are applied, and the final piece of content is created and for instance stored in a media file for further distribution.

### Problem Statement

A problem is to find out techniques for increasing the personalization options. Some particular cases of the problem are discussed here below.

### Metadata-Driven Personalization in NGA is Today Single-User-Only

Personalization as it is enabled by NGA systems such as MPEG-H Audio can be applied on demand during playback. The current state of personalization can be temporarily stored in the end user device, more specifically in the module of the device that implements the “user interface manager” (UI manager) functional block. The UI manager may connect the (Graphical) User Interface (UI) to the bitstream reader/writer, reads metadata from the bitstream and writes user interactivity event packets back to the bitstream.

However, those storage scenarios are very limited in the currently available systems to the one end user device that is currently in use by one user. Scenarios beyond a single device and a single end user are not foreseen.

It is not possible to transfer those personalization settings to other devices so that a user can start a personalized experience on one device and continue that on a second device without applying the same personalization steps again. It is also not possible to share the personalization settings with other users that consume the same content on other devices either at the same or another point in time, e.g., for a socialized, connected media experience within a group of friends.

This would require a metadata environment and a metadata specification of the personalization settings that is also machine readable so that several devices can read, parse and apply those settings during content playback. It would also require mechanisms to uniquely connect those settings to the respective pieces of content, and to those users that are authorized to apply those settings. Another requirement is to enable storage, delivery and sharing of the personalization metadata separate from the referenced media files and streams. The media files and streams are often encrypted for delivery, especially in scenarios like SVOD (subscription video on demand), and thus the media assets (bitstreams), for instance audio, are not accessible by the user and cannot be modified.

In today's broadcast and streaming applications that enable NGA use cases, a single bitstream is delivered over the air or streamed over the top to multiple users. Each user has then the option to individually interact with the audio content and select its preferred options at any point in time. It is currently not possible to create a social, joint experience where multiple users can interact with the same content and jointly or separately experience the same personalization options.

### Social Media Sharing of Personalized Content Today is not Efficient

Sharing of personalized content through social media applications as outlined above is not efficient: complete content files are downloaded, modified and uploaded again. That is not efficient, because the content assets themselves are modified for personalization, resulting in high datarate demands as the complete media has to be transferred. It is not possible today to transfer only the personalization as instruction or message, for instance in the form of metadata in a decoupled way from handling the media content assets.

Additionally, the social experience aspect is limited. One user personalizes content, the next user(s) consume it, and so on. It is not possible today to share personalization for an immediate application during media playback and a shared, connected experience within a group of users that consume the same content at the same time in different locations on their own end user devices.

It is also not always possible to personalize content, if the media assets are not accessible for modification by the users, for instance if they are protected through encryption. Today it is not possible to only share the personalization itself as an instruction or message without modification of the content assets.

The content owners might also not want to always allow modification of the assets, while personalization for consumption would be ok. It is not possible today to describe within the content file the scope of personalization that is allowed and how the personalization could be shared.

### SUMMARY

An embodiment may have a streaming client device, comprising: a communication interface, to receive, from a content service provider, at least one media stream, and, from an interactivity server, personalization option metadata enabling personalization options for rendering the at least one media stream according to the personalization options; a metadata engine, to generate personalization settings addressing the personalization options, wherein the communication interface is configured to transmit, to at least one second streaming client device through the interactivity server, personalization metadata describing personalization settings for the at least one media stream, the streaming client device being configured to generate the personalization metadata in a file independent from the at least one audio stream.

Another embodiment may have a streaming client device, comprising: a communication interface, to receive, from a content service provider, at least one media stream, the streaming client device being configured for rendering the at least one media stream according to personalization options; a metadata engine, to generate personalization settings addressing the personalization options, wherein the communication interface is configured to transmit, to at least one second streaming client device through an interactivity server, personalization metadata describing the personalization settings for the at least one media stream, the streaming client device being configured to generate the personalization metadata in a file independent from the at least one audio stream.

Another embodiment may have a streaming client device comprising: a communication interface to receive, from a content service provider, at least one media stream, wherein the communication interface is configured to request to, and/or receive from a second streaming client device through an interactivity server, personalization metadata describing personalization settings for the at least one media stream, the personalization metadata being in a file independent from the at least one media stream, a metadata engine, configured to apply personalization settings, obtained from the personalization metadata, to personalization options, so as to provide to a decoder, or a transcoder, the at least one media stream with the personalization settings.

Another embodiment may have a streaming server system comprising: a repository, to store, in association with a plurality of media streams, personalization option metadata enabling personalization options for rendering the at least one media stream according to the personalization options; a communication interface, configured to: transmit, to a first streaming client device, personalization option metadata enabling personalization options for rendering the at least one media stream according to the personalization options; receive, from the first streaming client device, personalization metadata describing personalization settings addressing the personalization options, so that the personalization metadata are stored in the repository in association with the at least one media stream, the personalization metadata being in files independent from the at least one media stream; transmit, to the at least one second streaming client device, the personalization metadata.

Another embodiment may have a method for enabling a shared personalized experience amongst multiple media receiving devices, the method comprising: sending a media stream which contains metadata that enable individual personalization options for each user on a media receiving device; receiving the media stream by at least two independent media receiving devices; at least one user interacting with the media content on at least one first media receiving device and applying his preferred personalization options to the content on the at least one first media receiving device; sharing media content specific and personalized settings from the at least one first media receiving device to the at least one second media receiving device, such that the at least one second media receiving device receives at least the media content, a content identifier, the personalization settings, synchronization and/or timing information describing the time of each personalization setting change and control and/or personalization metadata describing the allowed interactivity and/or personalization settings; wherein the at least one second media receiving device applies the personalization settings associated with the media content and the personalization settings created on the one first media receiving device using the received synchronization and/or timing information.

According to an example, there is provided a streaming client device comprising:
a communication interface, to receive, from a streaming server system and/or from another streaming client device, at least one media stream and personalization option metadata enabling personalization options for rendering the at least one media stream according to the personalization options;
a metadata engine (personalization engine), to generate personalization settings addressing the personalization options,
wherein the communication interface is configured to transmit, to the streaming server system and/or to at least one second streaming client device, and/or to store, personalization metadata describing personalization settings of the at least one media stream.

According to an example, there is provided a streaming client device comprising:
a communication interface, to receive, from a streaming server system and/or from another streaming client device, at least one media stream, the streaming client device being configured for rendering the at least one media stream according to personalization options;
a metadata engine (personalization engine), to generate personalization settings addressing the personalization options,
wherein the communication interface is configured to transmit, to the streaming server system and/or to at least one second streaming client device, personalization metadata describing the personalization settings of the at least one media stream.

According to an example, the streaming client device may be configured to generate the personalization metadata according to, or at least conditioned by, the state of the streaming client device.

According to an example, the streaming client device may be configured to generate the personalization metadata based on, or triggered by, a user.

According to an example the streaming client device may be configured to generate the personalization metadata to include at least one timing information indicating a time point in the at least one media stream in which an event in a personalization session has occurred.

According to an example, the streaming client device may be configured to define the timing information based on event(s) defined by the user through user's input(s).

According to an example the streaming client device may be configured to generate the personalization metadata to include at least one address identification which is a link or other information on how to find out the at least one stream and/or an identifier associated to the at least one media stream.

According to an example the streaming client device may be configured to generate the personalization metadata, or another communication message, to include at least one authorization information, indicating a level of restriction of the at least one media stream which subscriber or streaming client device, or class of subscribers or streaming client devices, is admitted to receive the personalization metadata.

According to an example the streaming client device may be configured to configured to generate the personalization metadata in a file independent of the at least one audio stream.

According to an example, the streaming client device may have a personalization metadata in the same file of the at least one media stream.

According to an example, the streaming client device may be configured to transmit, to the streaming server system, the personalization metadata towards at least one second streaming client device, so as to set the second streaming client device according to the personalization metadata.

According to an example, the streaming client device may be configured to:
receive the at least one media stream from the streaming server system and synchronously to at least one second streaming client device,
in parallel, transmit, to the streaming server system, personalization metadata associated with already provided portions of the at least one media stream.

According to an example the streaming client device may be configured to:
receive the at least one media stream from a second streaming client device and synchronously to the second streaming client device,
in parallel, transmit, to the streaming server system, personalization metadata associated with already provided portions of the at least one media stream.

According to an example, the streaming client device may be configured to:
following the reception of acknowledgment or non-acknowledgment information from the streaming server system, and/or from a second streaming client device, providing information whether the at least one second streaming client device has received the personalization metadata, perform at least one of the following actions:
provide an alarm to the user; and
automatically change the personalization metadata.

According to an example, the streaming client device may be configured to:
following the reception of an evaluation acknowledgment or non-acknowledgment packet to the streaming server system, and/or from a second streaming client device, indicating the result of an evaluation, by the at least one second streaming client device, on whether the personalization settings match the capabilities of the at least one second streaming client device, perform at least one of the following actions:
provide an alarm to the user; and
automatically change the personalization metadata.

According to an example, the streaming client device may be configured to generate the personalization metadata to include device related personalization data.

According to an example, the device related personalization data may include target loudness level.

According to an example, the device related personalization data may include DRC (Dynamic Range Control) settings.

According to an example, the device related personalization data may include at least one of preferred dialog level settings, preferred language settings, and preferred accessibility settings.

According to an example, the streaming client device may be configured to send recommendation information.

According to an example, the streaming client device may be configured to:
the communication interface is configured to request to, and/or receive from, the streaming server system and/or a second streaming client device, further personalization metadata generated by the second streaming client device and describing personalization settings of the at least one media stream,
wherein the metadata engine (personalization engine) is configured to apply the personalization settings, obtained from the further personalization metadata, to personalization options, so as to provide to a decoder, or a transcoder, the at least one media stream with the personalization settings.

According to an example, the streaming client device may comprise:
a communication interface to receive, from a streaming server system, and/or from a second streaming client device, at least one media stream, wherein the communication interface is configured to request to, and/or receive from, the streaming server system, and/or from the second streaming client, personalization metadata describing personalization settings of the at least one media stream,
a metadata engine (personalization engine), configured to apply personalization settings, obtained from the personalization metadata, to personalization options, so as to provide to a decoder, or a transcoder, the at least one media stream with the personalization settings.

According to an example, the streaming client device may comprise:
a communication interface to receive, from a streaming server system, and/or from a second streaming client, at least one media stream, wherein the communication interface is configured to request to, and/or receive from, the streaming server system and/or the second streaming client device, personalization metadata describing personalization settings of the at least one media stream,
a metadata engine (personalization engine), configured to provide to a decoder, or a transcoder, the at least one media stream with the personalization settings.

According to an example, the streaming client device may be configured as a streaming client device.

According to an example the streaming client device may be configured to parse the personalization metadata to retrieve at least one timing information indicating a time point in the at least one media stream in which an event in a personalization session has occurred.

According to an example, the streaming client device may be configured so that a new personalization session and/or a new playback starts using the personalization settings of the at least one media stream up to the time point, and in such a way that for the subsequent portion of the at least one media stream after the time point, the personalization settings are changed.

According to an example, the streaming client device may be configured to parse the personalization metadata to retrieve at least one address identification and/or an identifier associated to the at least one media stream, so as to send a request to the streaming server system, and/or the second streaming client, for streaming the at least one media stream.

According to an example, the streaming client device may be configured to parse the personalization metadata, or another message transmitted from another streaming client device to retrieve at least one authorization information, indicating a level of restriction of the at least one media stream, e.g. which subscriber, or class of subscribers, is admitted to receive the personalization metadata.

According to an example, the streaming client device may be configured to parse the personalization metadata, or another message transmitted from another streaming client device to retrieve information on at least one state of the other streaming client device so as to apply the at least one state, completely or partially, to the streaming client device.

According to an example, the streaming client device may have a personalization metadata in a file independent of the at least one audio stream.

According to an example, the device may have a personalization metadata in the same file of the at least one media stream.

According to an example, the streaming client device may be configured to parse the personalization metadata to retrieve device related personalization data,
wherein the metadata engine (personalization engine) is configured to apply the device related personalization data to the personalization options and/or to the personalization settings.

According to an example, the device related personalization data may include target loudness level.

According to an example, the device related personalization data may include DRC settings,

According to an example, the device related personalization data may include at least one of preferred dialog level settings, preferred language settings, and preferred accessibility settings.

According to an example, the streaming client device may be configured to:
receive the at least one media stream synchronously to another streaming client device,
in parallel, receive, from the streaming server system and/or from a second streaming client, personalization metadata associated with already provided portions of the at least one media stream, the personalization metadata being associated with portions of the at least one media stream,
wherein the metadata engine (personalization engine) is configured to apply the personalization settings obtained from the personalization metadata,
wherein the metadata engine (personalization engine) is configured for generating new personalization metadata,
wherein the streaming client device is configured to transmit to the streaming server system, and/or to the second streaming client, the new personalization metadata with timing information providing information on when, in the at least one media stream, the new personalization metadata are to be applied.

According to an example, the received personalization metadata include timing information of the already provided portions of the at least one media stream, so that the metadata engine (personalization engine) applies the personalization settings obtained from the personalization metadata synchronously to the timing information (142).

According to an example, the streaming client device may be configured to:
at the reception of a personalization metadata associated with already provided portions of the at least one media stream, transmit a reception acknowledgment or non-acknowledgment packet to the streaming server system, and/or to the second streaming client, indicating the reception or non-reception of a personalization metadata.

According to an example, the streaming client device may be configured to:
at the verification of non-reception of a personalization metadata associated with already provided portions of the at least one media stream, transmit a reception non-acknowledgment packet to the streaming server system, and/or to the second streaming client, indicating the reception or non-reception of a personalization metadata.

According to an example, the streaming client device may be configured to:
evaluate whether the personalization settings have been successfully applied, and send an evaluation acknowledgment or non-acknowledgment packet to the streaming server system, and/or to the second streaming client, indicating the result of the evaluation.

According to an example, the streaming client device may have a metadata engine (personalization engine) configured to modify the personalization settings obtained from the personalization metadata to generate subsequent personalization settings addressing subsequent personalization options and/or personalization settings,
wherein the communication interface is configured to transmit, to the streaming server system and/or to the second streaming client, and/or to store, subsequent personalization metadata describing subsequent personalization settings of the at least one media stream.

According to an example the streaming client device may be configured to extract the personalization settings from the personalization metadata and to perform an evaluation on whether the personalization settings match the capabilities of the streaming client device and, in case of positive result of the evaluation, the personalization settings are actually applied, and in case of negative result of the evaluation, the personalization settings are not applied and/or an evaluation non-acknowledgement is sent to the streaming server system and/or to the second streaming client.

According to an example, the streaming client device may be configured to:
receive, from the streaming server system and/or the second streaming client, further personalization metadata describing personalization settings addressing personalization options,
wherein the metadata engine (personalization engine) is configured to apply the personalization metadata to obtain the personalization settings, and the further personalization metadata to obtain further personalization settings.

According to an example, the streaming client device may be configured to fuse together the personalization settings and the further personalization settings using a synthesis technique, by mixing channels personalized through the personalization settings with further channels personalized through the further personalization settings.

According to an example, the streaming client device may be configured to:
receive, from the streaming server system and/or to the second streaming client, information regarding the presence of the personalization metadata in association with the request, from the steaming client device, of the at least one media stream, and/or in association to a suggestion, from the streaming server system and/or to the second streaming client, of the provision of the at least one media stream.

According to an example, the streaming client device may be configured to:
receive and decode and/or transcode and/or render the at least one media stream according to first personalization settings;
switching to second personalization settings.

According to an example, the streaming client device may be configured for fusing together the first personalization settings and the second personalization settings, using a synthesis technique, by mixing first channels personalized through the first personalization settings with second channels personalized through the second personalization settings.

According to an example, the streaming client device may be configured to generate new personalization metadata from the second personalization settings, and send the new personalization metadata to the streaming server system and/or the second streaming client.

According to an example, the streaming client device may be configured to insert, in the personalization metadata, timing information indicating the timing at which the new personalization metadata are to be applied.

According to an example, the streaming client device may be configured to receive and/or send recommendation information.

According to an example, the streaming client device may have a media system used for enabling a shared multi-device and multi-user personalized experience is MPEG-H 3D Audio.

According to an example, there is provided a streaming server system comprising:
a repository, to store a plurality of media streams and, for at least one media stream of the plurality of media streams, personalization option metadata enabling personalization options for rendering the at least one media stream according to the personalization options;
a communication interface, configured to:
transmit, to a first streaming client device at least one media stream and personalization option metadata enabling personalization options for rendering the at least one media stream according to the personalization options;
receive, from the first streaming client device personalization metadata describing personalization settings addressing the personalization options, so that the personalization metadata are stored in the repository in association with the at least one media stream;
transmit, to at least one second streaming client device, the personalization metadata and the at least one media stream.

According to an example, there is provided a streaming server system comprising:
a repository, to store, in association with a plurality of media streams, personalization option metadata enabling personalization options for rendering the at least one media stream according to the personalization options;
a communication interface, configured to:
transmit, to a first streaming client device personalization option metadata enabling personalization options for rendering the at least one media stream according to the personalization options;
receive, from the first streaming client device personalization metadata describing personalization settings addressing the personalization options, so that the personalization metadata are stored in the repository in association with the at least one media stream;
transmit, to the at least one second streaming client device, the personalization metadata.

According to an example, the streaming server system may be configured to transmit, to the at least one second streaming client device, the personalization metadata in coordination with the transmission of the at least one media stream from another streaming server system.

According to an example, the streaming server system may have a personalization metadata, or another communication transmitted by the first streaming client device which includes an authorization information, indicating a level of restriction of the at least one media stream, e.g. which subscriber or client device, or class of subscribers or client devices, is admitted to receive the personalization metadata.

According to an example, streaming server system may be configured to authenticate the at least one second streaming client device based on the authorization information.

According to an example, the streaming server system may have a personalization metadata which is in a file independent of the at least one media stream.

According to an example, the streaming server system may have an independent file which is stored in the repository together with a pointer to the address of the at least one media stream in the repository.

According to an example, the streaming server system may have a personalization metadata which is in the same file of the at least one media stream.

According to an example, the streaming server system may have an independent file which is stored in the repository together with a pointer to the address of the at least one media stream in a different repository.

According to an example, the streaming server system may be configured to:
synchronously transmit, or control the transmission of, the at least one media stream to both the first streaming client device and the at least one second streaming client device,
in parallel, receive, from the first streaming client device personalization metadata associated with already provided portions of the at least one media stream, and
retransmit, to the at least one second streaming client device, the personalization metadata associated with already provided portions of the at least one media stream, wherein the personalization metadata include timing information of the already provided portions of the at least one media stream.

According to an example, the streaming server system may be configured to:
following the reception of an acknowledgment or non-acknowledgment packet from the least one second streaming device indicating the reception or non-reception of a personalization metadata, retransmit the personalization metadata to the at least one second streaming client device.

According to an example, the streaming server system may be configured to:
following the reception of an evaluation acknowledgment or non-acknowledgment packet to the streaming server system indicating the result of an evaluation, by the at least one second streaming client device, on whether the personalization settings have been successfully applied, transmit evaluation acknowledgment or non-acknowledgment information to the first client device.

According to an example, the streaming server system may be configured to:
following the reception of an evaluation acknowledgment or non-acknowledgment packet to the streaming server system indicating the result of an evaluation, by the at least one second streaming client device, on whether the personalization settings match the capabilities of the at least one second streaming client device, transmit evaluation acknowledgment or non-acknowledgment information to the first client device.

According to an example, the streaming server system may be configured to:
receive, from at least one second streaming client device, further personalization metadata describing personalization settings addressing the personalization options, so that the further personalization metadata are stored in the repository in association with the at least one media stream, and
provide, to the at least one second streaming client device, also the further personalization metadata.

According to an example, the streaming server system may be configured to:
receive, in the personalization metadata, device related personalization data, and
   transmit the personalization metadata with the device related personalization data.

According to an example, the streaming server system may be configured to:
transmit, to the at least one second streaming client device, information regarding the presence of the personalization metadata in association with the request, from the steaming client device, of the at least one media stream, and/or in association to a suggestion, from the streaming server device, of the provision of the at least one media stream.

According to an example, the streaming server system may be configured to:
receive, from at least one second streaming client device, second personalization metadata associated with already provided portions of the at least one media stream, the second personalization metadata including timing information indicating in which point of the at least one media stream the second personalization metadata are to be applied; and
generate new personalization metadata from the personalization metadata and the second personalization metadata;
transmit the new personalization metadata to first streaming client device and/or at least one further second streaming device and further second streaming device.

According to an example, the streaming server system may be configured to generate the new personalization metadata by combining together the personalization metadata and the second personalization metadata through the timing information of the second personalization metadata and timing information of the personalization metadata.

According to an example, the streaming server system may be configured to generate the new personalization metadata by deciding which of the personalization metadata, between the personalization metadata and the second personalization metadata, are to be used for the new personalization metadata based on pre-defined priorities.

According to an example, the streaming server system may be configured to:
receive, from at least one second streaming client device, second personalization metadata associated with already provided portions of the at least one media stream, the second personalization metadata including second timing information indicating in which point of the at least one media stream the second personalization metadata are to be applied; and
   receive, from at least one other second streaming client device, third personalization metadata including third timing information indicating in which point of the media stream the third personalization metadata are to be applied;
   generate new personalization metadata from at least the second personalization metadata and the second personalization metadata;
transmit the new personalization metadata to the first streaming client device and/or the at least one second streaming device and further second streaming device.

According to an example, the streaming server system may be configured to generate the new personalization metadata by combining together the second personalization metadata and the third personalization metadata through the timing information of the second personalization metadata and timing information of the third personalization metadata.

According to an example, the streaming server system may be configured to generate the new personalization metadata by deciding which of the personalization metadata, between at least the third personalization metadata and the second personalization metadata, are to be used for the new personalization metadata based on pre-defined priorities.

According to an example, the streaming server system may be further configured to receive and/or send recommendation information to provide instructions on how to personalize the content playback experience in a given listening environment for a specific user.

According to an example, the streaming server system may have a media system used for enabling a shared multi-device and multi-user personalized experience is MPEG-H 3D Audio.

According to an example, there is provided a streaming method, comprising:
receiving, from a streaming server system and/or a second streaming client device, at least one media stream and/or personalization option metadata enabling personalization options;
generating personalization settings addressing the personalization options,
transmitting, to the streaming server system and/or second streaming client device, and/or storing, personalization metadata describing personalization settings of the at least one media stream.

According to an example, there is provided a streaming method, comprising:
receiving, from a streaming server system and/or a second streaming client device, at least one media stream and/or personalization option metadata enabling personalization options;
generating personalization settings,
transmitting, to the streaming server system and/or second streaming client device, personalization metadata describing personalization settings.

According to an example, there is provided a streaming method comprising:
receiving at least one media stream;
performing at least one of:
requesting to, and/or receiving from personalization metadata describing personalization settings of the at least one media stream,
providing to a decoder, or a transcoder, the at least one media stream with the personalization settings.

According to an example, there is provided a streaming method comprising:
storing a plurality of media streams and, for at least one media stream of the plurality of media streams, personalization option metadata enabling personalization options for rendering the at least one media stream according to the personalization options;
transmitting, to a first streaming client device, at least one media stream and personalization option metadata enabling personalization options for rendering the at least one media stream according to the personalization options;
receiving, from the first streaming client device, personalization metadata describing personalization settings addressing the personalization options, and storing the personalization metadata in the repository in association with the at least one media stream;
transmitting, to the at least one second streaming client device, the personalization metadata.

According to an example, there is provided a streaming method comprising:
storing, in association with a plurality of media streams personalization option metadata enabling personalization options for rendering the at least one media stream according to the personalization options;
transmitting, to a first streaming client device personalization option metadata enabling personalization options for rendering the at least one media stream according to the personalization options;
receiving, from the first streaming client device, personalization metadata describing personalization settings addressing the personalization options, so that the personalization metadata are stored in the repository in association with the at least one media stream;
transmitting, to the at least one second streaming client device the personalization metadata.

According to an example, there is provided a method for enabling a shared personalized experience amongst multiple media receiving devices, the method comprising:
sending a media stream which contains metadata that enable individual personalization options for each user on a media receiving device;
receiving the media stream by at least two independent media receiving devices;
at least one user interacting with the media content on at least one first media receiving device and applying his preferred personalization options to the content on the at least one first media receiving device;
sharing media content specific and personalized settings from the at least one first media receiving device to the at least one second media receiving device such that the at least one second media receiving device receives at least the media content, a content identifier, the personalization settings, synchronization and/or timing information describing the time of each personalization setting change and control and/or personalization metadata describing the allowed interactivity and/or personalization settings;
wherein the at least one second media receiving device applies the personalization settings associated with the media content and the personalization settings created on the one first media receiving device using the received synchronization and/or timing information.

According to an example, the method may have at least one first media receiving device and the at least one second media receiving device are controlled by a single user and the personalization settings are shared seamlessly across the first and second media receiving devices.

According to an example, the method may have at least one first media receiving device is controlled by one user and the at least one second media receiving device is controlled by a second user and the personalization settings are shared amongst the two independent users enabling a joint personalized experience.

According to an example, the method may have a personalization settings from at least one media receiving device are transmitted in the form of a metadata message to an external entity or a media server which analyses, prioritizes and/or combines the received metadata messages before sharing any metadata message with the at least one second media receiving device.

According to an example, the media content may be, of be encoded in, an audio stream (or, in some examples, in a video stream, or both).

According to an example the method may have a personalization settings created on the at least one first media receiving device are provided in a metadata packet derived from the available user interface settings and wherein the metadata packet contains a full (or almost full) description of the current state of the user interaction settings on the at least one first media receiving device.

According to an example, the method may have a personalization settings created on the at least one first media receiving device are provided in a metadata packet derived from the available user interface settings and wherein the metadata packet enables the creation of at least one user interaction event on the at least one second media receiving device.

According to an example, the method may have a personalization settings created on the at least one first media receiving device are provided in a metadata packet derived from the available user interface settings and wherein the metadata packet triggers the same personalized reproduction of the media on the at least one second media receiving device as created on the at least one first media receiving device, wherein the media reproduction is different than the media reproduction of the content without the personalization settings created on the at least one first media receiving device.

According to an example, the method may have a metadata packet contains additionally timing information associated with at least one personalization setting created on the at least one first media device.

According to an example, the method may have media content which is provided in the form of a stream or file which contains the compressed media, metadata and Social Media Control Data.

According to an example, the method may have a Social Media Control Data which contains amongst others at least one of the following data attributes:
a content media identifier;
an indication that the current media stream allows a shared experience;
an indication of the number of available user categories and a user category identifier for each use category;

According to an example, the method may have at least one user category is indicated in the media content and the at least one user category enables media receiving devices associated with this user category to share personalization settings with other media receiving devices.

According to an example, the method may have at least one user category is indicated in the media content and the at least one user category enables media receiving devices associated with this user category to receive personalization settings from other media receiving devices.

According to an example, the method may have a media receiving device which contains a Social Media Processor that can receive and/or generate metadata packets or Personalized Social Media Messages.

According to an example, the method may have metadata packets or Personalized Social Media Messages which contain amongst others:
Personalized Social Media Message identification information,
content identification information,
current media position information,
content related personalization data,
environment or device related personalization data, and
user related information.

According to an example, the method may have a Social Media Processor which is configured to generate Personalized Social Media Messages and is responsible to perform at least one of the following functions:
Receive information about the Social Media Control Message Data available in the media stream or file;
Receive information about the user interactions on current media receiving device;
Receive synchronization and timing information and other data from the media receiving device system layer required to accurately time-stamp any user interaction;
Generate a Personalization Social Media Message and embed the personalization information, timing and synchronization information;
Send the Personalization Social Media Message to an Interactivity Server.

According to an example, the method may have a Social Media Processor which is configured to receive Personalized Social Media Messages and responsible to perform at least one of the following functions:
Receive a Personalization Social Media Message from an Interactivity Server;
Parse a Personalization Social Media Message and embed the personalization settings to be applied into corresponding messages according to the media system in use;
Process the timing and synchronization information of the Personalization Social Media Message and of the local timing of the content played out locally on the media receiver;

According to an example, the method may have an Interactivity Server which is configured to perform at least one of the following functions:
Authenticate users and grant access to specific personalization settings based on user categories;
Store a database of all content social media identifiers that have been created for specific applications;
Link to one or more social media platforms;
Send and receive user invites to specific groups sharing the same experience;
Establish a relationship between users based on the user access information in the social media messages and the user information from other user management and authentication servers;
Receive Personalization Social Media Messages from one or more users;
Send Personalization Social Media Messages to one or more users;

According to an example, the method may have an Interactivity Server which is further configured to prioritize between multiple Personalization Social Media Messages received from multiple users based on various criteria, including the user category, the timing information and the personalization setting type.

According to an example, the method may have an Interactivity Server which is further configured to create at least one new Personalization Social Media Message based on information received from one or more users and generate the timing information required for alignment of the personalization settings across all users part of the multi-user experience and share the new Social Media Message with all users.

According to an example, the method may have at least one Personalization Recommendation Message which is provided to more than one media receiving device and may comprise (e.g. consist of) information for instructing the media receiving devices how to personalize the content playback experience in a given environment for a given media content.

According to an example, the method may have a Personalization Recommendation Message which may comprise (e.g. consist of) at least one of the following:
a Personalization Recommendation Message identification information,
content and content genre identification information,
user group information,
content related personalization data,
listening environment information
playback environment and device capability information, and
user group and user related information.

According to an example, the method may have an Interactivity Server which is further configured to perform at least one of the following functions:
Synchronize the exchange of social media messages and content media time lines for the case of linear or live content media, like broadcast content or live streaming, including the alignment of user events and messages.
Organize the exchange of Personalization Recommendation Messages between content providers or social media platforms and media receivers.
Act as Personalization Recommendation Mapper to map and adapt the recommendations to specific content assets or specific media receivers or user preferences.
Generate specific Personalization Social Media Messages from Personalization Recommendation Messages after such a mapping process.

According to an example, the method may have a media system used for enabling a shared multi-device and multi-user personalized experience is MPEG-H 3D Audio.

According to an example there is provided a non-transitory storing device storing instructions which, when executed by a processor, cause the processor to perform a method as described above.

According to an aspect, there is provided a streaming client device, comprising:
a communication interface, to receive, from a streaming server system, at least one media stream and personalization option metadata enabling personalization options for rendering the at least one media stream according to the personalization options;
a metadata engine, to generate personalization settings addressing the personalization options,
wherein the communication interface is configured to transmit, to the streaming server system, and/or to store, personalization metadata describing personalization settings of the at least one media stream.

According to an aspect, there is provided a streaming client device comprising:
a communication interface to receive, from a streaming server system, at least one media stream, wherein the communication interface is configured to request to, and/or receive from, the streaming server system, personalization metadata describing personalization settings of the at least one media stream,
a metadata engine, configured to apply personalization settings, obtained from the personalization metadata, to personalization options and/or personalization settings, so as to provide to a decoder, or a transcoder, the at least one media stream with the personalization settings.

The streaming client device may be configured as a streaming client device according to a previous aspect.

According to an aspect, there is provided a streaming server system comprising:
a repository, to store a plurality of media streams and, for at least one media stream of the plurality of media streams, personalization option metadata enabling personalization options for rendering the at least one media stream according to the personalization options;
a communication interface, configured to:
transmit, to a first streaming client device, at least one media stream and personalization option metadata enabling personalization options for rendering the at least one media stream according to the personalization options;
receive, from the first streaming client device, personalization metadata describing personalization settings addressing the personalization options, so that the personalization metadata are stored in the repository in association with the at least one media stream;
transmit, to at least one second streaming client device, the personalization metadata and the at least one media stream.

According to an aspect, there is provided a streaming server system comprising:
a repository, to store, in association with a plurality of media streams, personalization option metadata enabling personalization options for rendering the at least one media stream according to the personalization options;
a communication interface, configured to:
transmit, to a first streaming client device personalization option metadata enabling personalization options for rendering the at least one media stream according to the personalization options;
receive, from the first streaming client device, personalization metadata describing personalization settings addressing the personalization options, so that the personalization metadata are stored in the repository in association with the at least one media stream;
transmit, to the at least one second streaming client device, the personalization metadata.

According to an aspect, the streaming server system may configure to transmit, to the at least

According to an aspect, there is provided a streaming method, comprising:
receiving, from a streaming server system, at least one media stream and/or personalization option metadata enabling personalization options;
generating personalization settings addressing the personalization options,
transmitting, to the streaming server system, and/or to storing, personalization metadata describing personalization settings of the at least one media stream.

According to an aspect, there is provided a streaming method comprising:
receiving, from a streaming server system, at least one media stream;
performing at least one of:
requesting to, and/or receiving from, the streaming server system personalization metadata describing personalization settings of the at least one media stream,
   applying personalization settings, obtained from the personalization metadata, to the personalization options,
providing to a decoder, or a transcoder, the at least one media stream with the personalization settings.

According to an aspect, there is provided a streaming method comprising:
storing a plurality of media streams and, for at least one media stream of the plurality of media streams, personalization option metadata enabling personalization options for rendering the at least one media stream according to the personalization options;
performing at least one of:
transmitting, to a first streaming client device, at least one media stream and personalization option metadata enabling personalization options for rendering the at least one media stream according to the personalization options;
receiving, from the first streaming client device, personalization metadata describing personalization settings addressing the personalization options, and storing the personalization metadata in the repository in association with the at least one media stream;
transmitting, to the at least one second streaming client device, the personalization metadata.

According to an aspect, there is provided a streaming method:
storing, in association with a plurality of media streams personalization option metadata enabling personalization options for rendering the at least one media stream according to the personalization options;
performing at least one of:
transmitting, to a first streaming client device personalization option metadata enabling personalization options for rendering the at least one media stream according to the personalization options;
receiving, from the first streaming client device, personalization metadata describing personalization settings addressing the personalization options, so that the personalization metadata are stored in the repository in association with the at least one media stream;
transmitting, to the at least one second streaming client device the personalization metadata.

According to an aspect, there is provided a method for enabling a shared personalized experience amongst multiple media receiving devices, the method comprising:
sending a media stream which contains metadata that enable individual personalization options for each user on a media receiving device;
receiving the media stream by at least two independent media receiving devices;
at least one user interacting with the media content on at least one first media receiving device and applying his preferred personalization options to the content on the at least one first media receiving device;
sharing his media content specific and personalized settings from the at least one first media receiving device to the at least one second media receiving device, such that the at least one second media receiving device receives at least the media content, a content identifier, the personalization settings, synchronization and/or timing information describing the time of each personalization setting change and control and/or personalization metadata describing the allowed interactivity and/or personalization settings;
wherein the at least one second media receiving device applies the personalization settings associated with the media content and the personalization settings created on the one first media receiving device using the received synchronization and/or timing information.

### BRIEF DESCRIPTION OF THE DRAWINGS

Embodiments of the present invention will be detailed subsequently referring to the appended drawings, in which:

FIG. 1 shows an example of streaming client device configured as generator of a personalization.

FIG. 2 shows an example of streaming client device configured as receiver (parser) of a personalization.

FIG. 3 shows an example of streaming client device.

FIG. 4 shows an example of an architecture around an interactivity server (streaming server system).

FIGS. 5 and 6 show operations according to examples.

FIG. 7 shows a Social Media Message Generator.

FIG. 8 shows an example of Social Media Message Processor.

FIG. 9 shows an example of streaming client device configured as generator of a personalization.

FIG. 10 shows an example of streaming client device configured as receiver (parser) of a personalization.

FIG. 11 shows an example of interactivity server (streaming server system).

FIG. 12 shown an example of interactivity server (first streaming server system) operating in coordination with a second streaming server system (streaming content service provider).

### DETAILED DESCRIPTION OF THE INVENTION

Here below reference is often made to at least one media stream. The at least one media stream may be or comprise, for example, an audio stream or at least one audios stream. The at least one media stream may be or comprise, for example, a video stream or at least one video stream. The at least one media stream may be or comprise, for example both an audio stream (e.g. at least one audio stream) and a video stream (e.g. at least one video stream).

At first, it is here noted that transmissions between streaming client devices (e.g. 10, 10a, 10b, 10c) and other devices may be of two types: there may be a transmission between a streaming client device (e.g. 10, 10a, 10b, 10c) and a server system (e.g. 20, 20′), and there may be a transmission between a streaming client device (e.g. 10a) and a second streaming client device (e.g. 10b, 10c). It may be that a transmission from the streaming server system provides at least one media stream to the streaming client device, but at the same time the streaming client device communicates with second streaming client device(s) to send and/or receive personalization metadata (see below). In other cases, a transmission from the server system provides at least one media stream to the streaming client device, and also the server system send transmits and/or receive personalization metadata (see below), which may be, for example, routed to second, further streaming client devices.

It is noted that each streaming client device may comprise (or be connected to, e.g. locally connected to) a decoder 40 (which may render the at least one media stream) or transcoder (which may re-encode the at least one media stream into another at least one media stream, e.g. according to a different encoding standard).

The audio stream may be, for example, in compressed form, and may be decompressed, for examples, by the decoder. The transcoder may re-compress the media stream, for examples according to another compression standard.

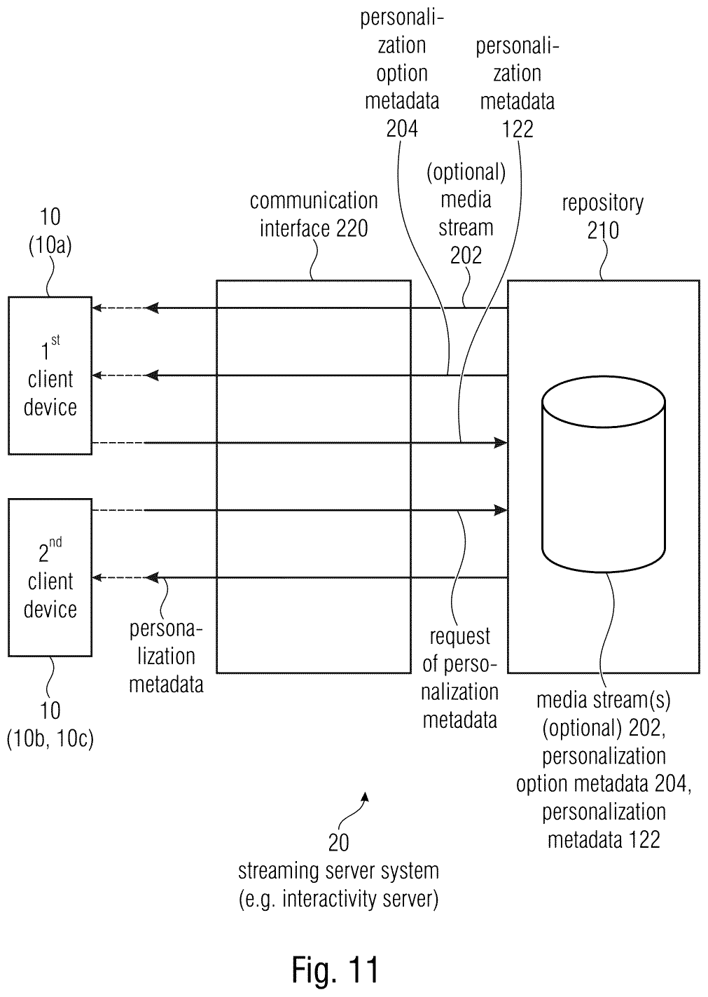

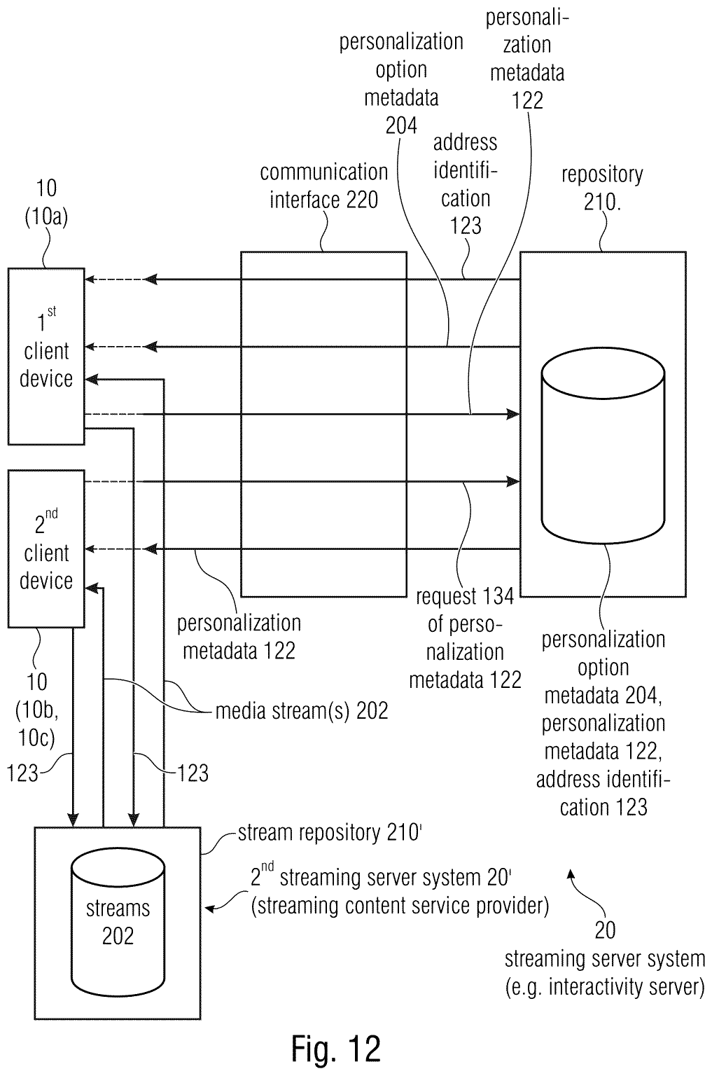

Here below, streaming client devices 10a, 10b, 10c are collectively referred to with 10. The streaming client devices 10a, 10b, 10c (10) communicate with each other through at least one streaming server system 20. The streaming client devices 10a, 10b, 10c (10) may be understood as receiving the same at least one media stream (e.g. audio and/or video stream) 202 (either through the streaming server system 20, also called “interactivity server”, as shown in FIG. 11; or through another streaming server system 20′, also called “streaming content service provider”, as shown in FIG. 12). (It is to be noted that both even in FIG. 12 the first streaming server system 20 and the second streaming server system 20′ may be seen, by the streaming client devices 10a, 10b, 10c, as being one single streaming server system divided in two partitions.)

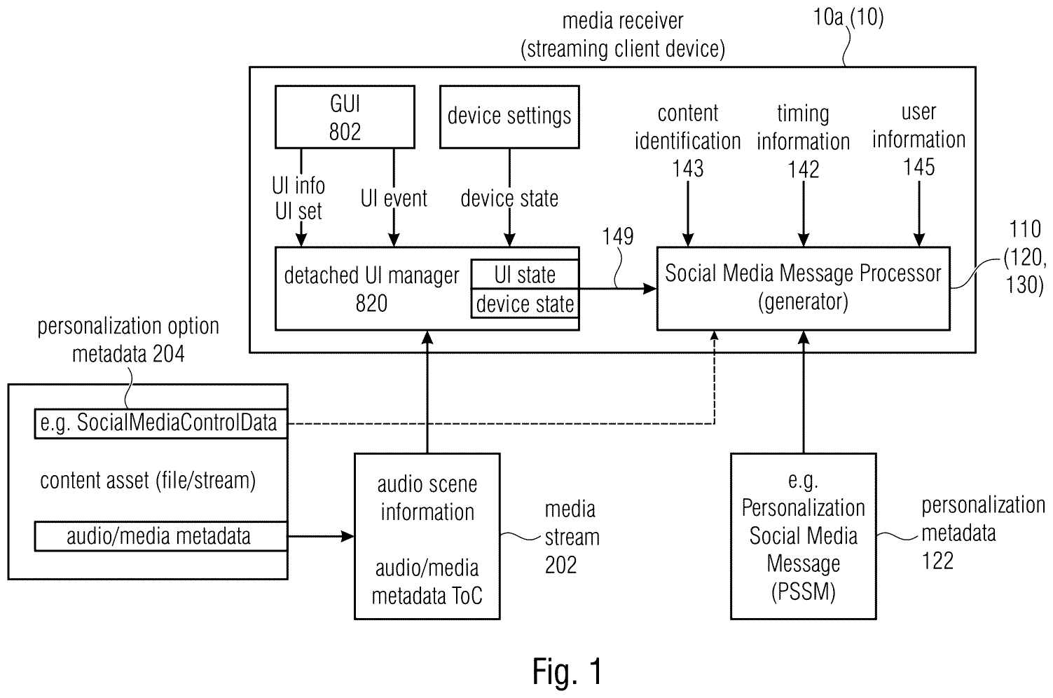

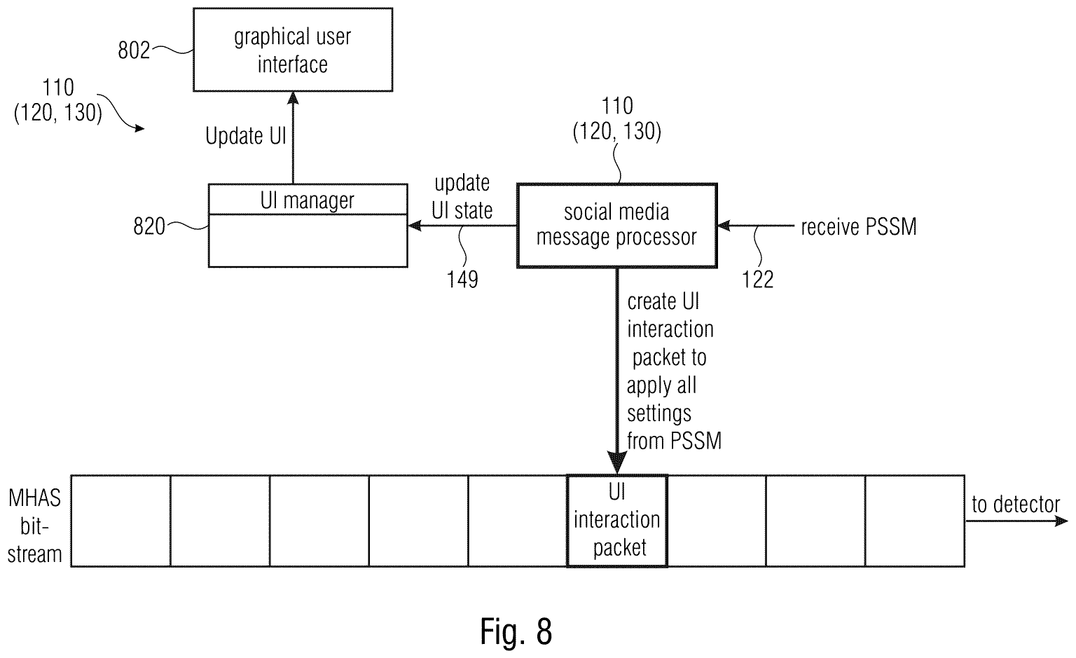

FIG. 9 shows an example of a first streaming client device 10 or 10a (which may be the identical, in examples, to any of the streaming client devices 10, 10b, 10c, disclosed below). In some examples, the first streaming client device 10a of FIG. 9 is the same of the streaming client device 10 (10a) of FIG. 1. The first streaming client device 10 (10a) may comprise a communication interface 120. The communication interface 120 may receive, from a streaming service system 20, at least one media stream 202. The first streaming client device 10 (10a) may receive, from the streaming service system 20, at least one personalization option metadata 204. The personalization option metadata 204 may enable personalization options for rendering the at least one media stream 202 according to the personalization options. (It is to be noted that, in some examples, the personalization options may be defined locally. In addition or in alternative, it is not necessary for receiving the personalization option metadata 204 from the streaming service system 20.) The personalization options may include, for example, options that a user can adopt (e.g., dialog language, a particular remix, a particular channel mixing, a particular rendering, device related personalization data, interactivity options, etc.) for rendering the media stream 202. The first streaming client device 10 (10a) may comprise a metadata engine 130 (personalization engine). The metadata engine 130 may generate personalization settings 132 addressing the personalization options enabled by the personalization option metadata 204. The communication interface 120 may generate personalization metadata 122 (e.g., in metadata packets, also called personalization social media messages, PSMMs) describing the personalization settings 132 applied by the personalization engine 130 to the at least one media stream 202. The personalization metadata 122 may be sent by the communication interface 120 to the streaming server system 20, so that the streaming server system 20 forwards the personalization metadata 122 to at least one second streaming client device 10b, 10c (In alternative, the personalization metadata 122 may be sent directly to the at least one second streaming client device 10b, 10c, e.g. without interaction with the streaming service system 20). Therefore, at least one second streaming client device 10b, 10c (10) will have the possibility of receiving and using the personalization settings 132 written in the personalization metadata 122. Thus, remote users (operating through the at least one second streaming client device 10b or 10c) may enjoy the settings 132 defined by the first streaming client device 10a. The first streaming client device 10a may also store (e.g., in the communication interface 120 and/or in the metadata engine 130) the personalization metadata 122. Accordingly, the stored personalization metadata 122 may be used subsequently by the same user in the same first streaming client device 10a. It is to be noted that the communication interface 120 and the metadata engine 130 may, in some examples, be collectively called “social media message processor”.

The personalization metadata 122 may include, for example, timing information 142. The timing information 142 may indicate a time point in the at least one media stream 202 in which an event or a personalization session has occurred [e.g. the user has stopped or started the personalization, and/or has stopped or started the playback during which the personalization was occurring, or has inputted a command regarding the personalization, etc.]. [In some examples, a new personalization session and/or a new playback can start using the personalization settings 132 of the at least one media stream 202 up to the time point, and/or so that for the subsequent portion of the at least one media stream after the time point, the personalization settings can be changed]. In some examples, the timing information 142 may indicate a time point in the at least one media stream 202 to which an event in a personalization session refers. It is to be noted that the at least one media stream 202 also includes synchronization information for permitting the simultaneous playback of the at least one stream 202 by the different streaming client devices 10a, 10b, 10c.

The personalization metadata 122 may also include content identification 143 (which may, for example, identify the stream 202 and/or its address).

The personalization metadata 122 may include a user information 145 (e.g., information which identifies the streaming client device 10).

The personalization metadata 122 may include information on the user interface state 149, or more in general the state of the streaming client device (which may, for example, comprise content identification 143, and/or timing information 142, and/or user information 145, and/or synchronization information).

Therefore, the first streaming client device 10a may be configured to generate the personalization metadata 122 (e.g. from the settings 132) to include at least one address identification 145 [e.g. a link or other information on how to find out the at least one stream, e.g. using the syntax of the media platform or another syntax, e.g. a standardized syntax] and/or an identifier 145 [e.g. unique identifier] associated to the at least one media stream.

In addition, the first streaming client device 10a may generate the personalization metadata 122 (e.g. from the settings 132), or other message, to include at least one authorization information, indicating a level of restriction of the at least one media stream which subscriber, or class of subscribers, is admitted to receive the personalization metadata [e.g., public, reserved, only for some subscribers, only for the virtual friends, and so on].

The streaming client device 10a may be configured to generate the personalization metadata 122 may be in a file independent of the at least one audio stream 202 (e.g. in FIG. 11). The personalization metadata 122 may, in some examples, in the same file of the at least one media stream 202 (this may be, e.g., in FIG. 12, but it is not necessary). The personalization metadata 122 may be (both in the examples of FIG. 11 and FIG. 12) independent of the at least one audio stream 202. In other examples, the personalization metadata 122 are in the same file (or in a file dependence on) the at least one media audio stream 202. The first streaming client device 10 may transmit (e.g. through the streaming server system 20 the personalization metadata 122, or directly) towards at least one second client device 10b or 10c, so as to set the settings 132 of the at least one second client device 10b or 10c according to the personalization metadata 122.

The first streaming client device 10a may: receive the at least one media stream 202 (e.g. from the streaming server system 20 and/or from the at least one second client device 10b, 10c) and (e.g. synchronously to at least one second client device 10b, 10c), e.g. in parallel, transmit, (to the at least one second client device 10b, 10c, either directly or through the streaming server system 20), the personalization metadata 122 associated with portions (e.g. already provided portions) of the at least one media stream 202. The personalization metadata 122 may include timing information 142 on the already provided portions of the at least one media stream 202. In this way, it is possible to indicate which portion of the at least one media stream 202 is to be subjected to the settings 132 implied by the personalization metadata 122. For example, the timing information 142 may include information on a time point of the at least one media stream 202 from which the personalization metadata 122 apply, so that the users of the second streaming client devices 10b and 10c will enjoy the media content with the settings 132 conditioned by the personalization metadata 122 starting from the time point indicated in the timing information 142.

It is to be noted that this applies, for example, in real time, while multiple streaming media devices 10a-10c are receiving (and, e.g. rendering) the same media stream 202 simultaneously. In this way, the second streaming client devices 10b and 10c will automatically receive the new settings 132 in real time. On the other side, the same applies where the second streaming client devices 10b and/or 10c are receiving (and, e.g. rendering) the same media stream 202 after that the first streaming client device 10a has received (and e.g. rendered) the media stream 202: simply, the second streaming client devices 10b and/or 10c will start applying the new settings 132 (as defined by the timing information 142 in the personalization metadata 122) only starting from the time point at which the first streaming client device 10a has defined the new settings 132.

It is foreseen that this mechanism does not always occur conveniently, at least not in the situations in which a second streaming client device 10b or 10c, receiving the media stream 202 simultaneously to the first streaming client device 10a, cannot modify its settings 132 according to the personalization metadata 122: this could occur, perhaps, because the second streaming client device 10b or 10c does not have the same technical capability of the first streaming client device 10a for performing the same audio processing. In this case, there may be an error recovery strategy, such as:
The second streaming client device 10b or 10b may send (e.g. routed through the streaming system 20) an acknowledgment information (when the new settings 132 are correctly applied to the second streaming client device 10b or 10b) or non-acknowledgment information (when the new settings 132 are incorrectly applied to the second streaming client device 10b or 10b). The first streaming client device 10a may, following the non-reception (within a predetermined threshold time) of acknowledgment information or the reception non-acknowledgment information, perform at least one of the following actions:
provide an alarm to the user; and
automatically change the personalization metadata 122 [e.g., to go back to the previous personalization settings], and retransmit (e.g. through the streaming system 20) the changed personalization metadata 122.

In other cases, the second streaming client device 10b, 10c may transmit an evaluation acknowledgment or non-acknowledgment packet (e.g. through to the streaming server system 20 or directly, e.g. without intervention of the streaming server system 20) indicating the result of an evaluation, by the at least one second client device (10b, 10c), on whether the personalization settings match the capabilities of the at least one second streaming client device (10a, 10b). Accordingly, the first streaming client device 10 may, following the reception of the evaluation acknowledgment or non-acknowledgment packet, perform at least one of the following actions:
provide an alarm to the user; and
automatically change the personalization metadata 122 [e.g., to go back to the previous personalization settings], and retransmit (e.g. through the streaming system 20) the changed personalization metadata 122.

The personalization metadata 122 may include device related personalization data, which may include playback environment information (such as target loudness level or DRC (Dynamic Range Control) settings, e.g., living room, mobile, noisy environment, full dynamic range). The personalization metadata 122 may include device related personalization data, which may include preferred dialog level settings. The personalization metadata 122 may include device related personalization data, which may include preferred language settings, and preferred accessibility settings (audio description, etc.). The personalization metadata 122 may include metadata on how to personalize the mixing of channels. Accordingly, the user of the second streaming client device 10b or 10c will enjoy the same settings 132 as generated by the user of the first streaming client device 10a. Therefore, there is decreased the amount of time for resetting a remote client device 10b or 10c, for example.

The first streaming client device 10a may send, e.g. through the streaming server system 20 (or directly, e.g. without intervention of the streaming server system 20), recommendation information [e.g. to provide instructions on how to personalize the content playback experience in a given listening environment for a specific user]. The recommendation information may be, for example, extracted (e.g. automatically extracted) (e.g. by the streaming server system 20) from personalization metadata 122, so as to suggest, to a second streaming client device 10b or 10c, the settings 132 to be applied. This may have great advantages, for example, in a social media environment.

It is to be noted that operations discussed above may be mediated through the server system 20 (but in some examples may be direct, without intervention of the streaming server system 20), and may be in a social media environment. In some examples, the first and second streaming client devices 10a, 10b, 10c may be part of a client device group of streaming client devices which have the right of exchanging information with each other (e.g. “friends”, “contacts”, and so on). In some examples, the client device group is initiated with the intent of permitting the exchange of the personalization metadata 122.

It is also to note that the distinction between the first streaming client device 10a and the second streaming client device 10b, 10c may be only for explanatory purposes: the streaming client device 10a is the one which starts the personalization (generator), but in other cases it may be the streaming client device 10b which acts as generator, while the streaming client device could be the receiver (parser) which adopts the personalization settings 132 defined by the streaming client device 10b.

However, in general terms, the first streaming client device 10a may receive, together with at least one media stream 202, also personalization option metadata 204 which may permit the first streaming client device 10 (10a) to render the at least one media stream 202 according to personalization settings 132, which may be generated by the streaming client device 10 (10a). After that, the first streaming client device 10 (10a) may send the personalization settings 132 (e.g., in the form of personalization metadata 122, also called PSMM) to other streaming client devices 10b, 10c.

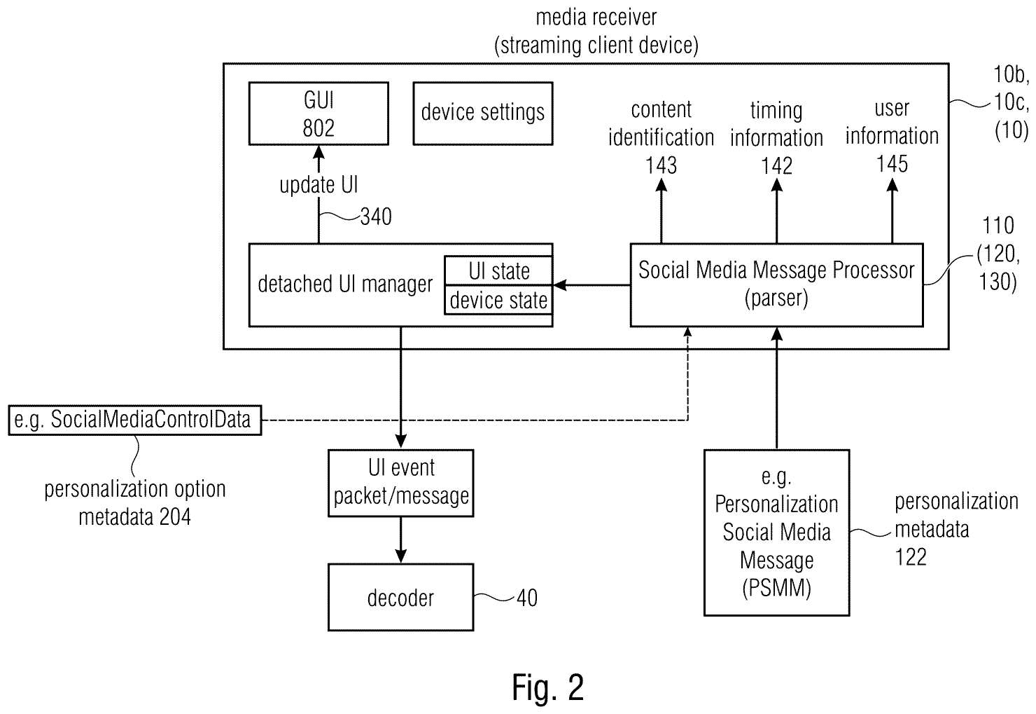

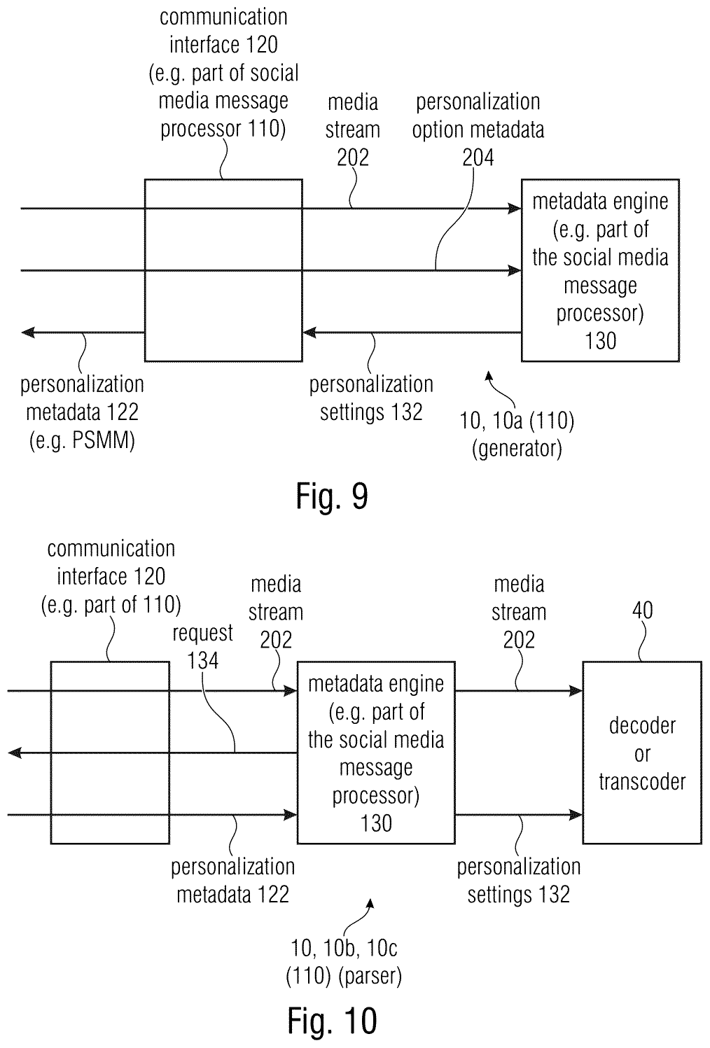

FIGS. 2 and 10 show the second streaming client device 10 (10b, 10c) which may receive the personalization metadata 122 (e.g., PSMM) from the first streaming client device 10a. The transmission and/or reception of the personalization metadata 122 may be performed through the streaming service system 20 (e.g., interactivity server) (but in some examples may be direct, e.g. without intervention of the streaming server system 20). The device 10b, 10c of FIG. 10 may be, in some examples, identical to the first device 10a of FIG. 2. The device of FIG. 10 may be identical to the devices of FIGS. 1 and/or 9, but in this case, the streaming client device 10 (10b, 10c) may simply receive some personalization metadata 122 sent by the streaming client device 10a of FIG. 9. This is the reason why the device of FIG. 9 is also called “generator” (intending that there is a generation of the personalization metadata 122), while the device of FIG. 10 is called “receiver” or “parser” (intending that the device receives the personalization metadata 122 from the device 10a of FIG. 9).

The at least one second streaming client device 10b, 10c may include, for example, a communication interface 120. The communication interface 120 may receive, from the streaming service system (interactivity server) 20 (or in some examples may bidirectly, e.g. without intervention of the streaming server system 20), or under the control of the streaming service system 20, at least one media stream 202 (in the example of FIG. 11, the at least one media stream 202 is received from the streaming service system 20, while in the in the example of FIG. 12, the at least one media stream 202 is received from another streaming service system 20′ e.g. under the control of the interactivity server 20, or in some examples without intervention of the streaming server system 20). [The communication interface 120 of the device 10b or 10c may send an evaluation acknowledgment or non-acknowledgment packet to the streaming server system 20, or in some examples directly to the streaming client device, indicating the result of an evaluation, by the at least one second client device (10a, 10b), on whether the personalization settings 132 match the capabilities of the at least one second streaming client device (10a, 10b), perform at least one of the following actions: provide an alarm to the user; and automatically change the personalization metadata].

The at least one second streaming client device 10b or 10c may include a metadata engine 130, which may apply, e.g., during a personalization session, personalization settings 132, obtained from the personalization metadata 122, to the personalization options and/or personalization settings, so as to provide to the decoder 40, or the transcoder 40, the at least one media stream 202 with the personalization settings 132.

As can be seen from FIG. 10, therefore, the communication interface 120 of the second streaming client device 10b or 10c may receive at least one media stream 202 and provide it to the metadata engine 130. The metadata engine 130 may provide the at least one media stream 202 to a decoder or transcoder 40. The at least one media stream 202 may be personalized through personalization metadata 122 (e.g., remotely generated by the first streaming client device 10a). The personalization metadata 122 may be, in the second device 10b or 10c, converted into personalization settings 132, which condition the rendering of the media stream 202. Even if FIG. 10 shows that the personalization settings 132 are provided to the decoder or transcoder 40 independently of the at least one media stream 202, they can, notwithstanding, be provided together. Hence, the at least one media stream 202 may already be personalized through the personalization metadata 122 when it is provided to the decoder or transcoder 40. FIG. 10 also shows a request 134, which is sent by the second streaming client device 10b, 10c to the streaming server system 20, and which the streaming server system 20 will forward to the first streaming client device 10a (but in some examples the request 134 may be direct, without the intervention of the server system 20). In this way, the second streaming client device 10b, 10c will receive the personalization metadata 122 from the first streaming client device 10a (either directly, or through the server system 20), so as to personalize the rendering of the at least one media stream 202 accordingly. The request 134 may follow, for example, the reception of a recommendation message from the first streaming client device 10a.

The second streaming client device 10b, 10c may parse the personalization metadata 122 to retrieve information written in the personalization metadata 122. For example, the second streaming client device 10b, 10c may parse the personalization metadata 122 to retrieve the timing information 142 indicating a time point in the at least one media stream 202 in which an event in the a personalization session has occurred [e.g. the user has stopped the personalization, and/or has stopped the playback during which the personalization was occurring, or more in general indicating the time portion of the media stream 202 at which the personalization settings 132 written in the personalization metadata 122 shall apply]. A new personalization session and/or a new playback can start using the old personalization settings 132 of the at least one media stream 202 up to the time point indicated by the timing information 142, and/or so that for the subsequent portion of the at least one media stream 202 after the time point indicated by the timing information 142, the personalization settings 132 will be changed according to the personalization metadata 122.

According to an example, the at least one second streaming client device 10b, 10c may parse the personalization metadata 122 to retrieve at least one address identification 123 [e.g. a pointer, a link or other information on how to find out the at least one stream 202, e.g. using the syntax of the media platform] and/or an identifier [e.g. unique identifier] associated to the at least one media stream 202, so as to send a request 134 to the streaming server system 20 for streaming the at least one media stream 202. This is in particular useful in the example of FIG. 12, where the at least one media stream 202 is not provided directly by the interactivity server (streaming server system) 20, but by a different streaming server system (streaming content service provider) 20′.

In addition or as an alternative, the second streaming client device 10c, 10c may parse the personalization metadata 122 (or other information) to retrieve at least one authorization information, indicating a level of restriction of the at least one media stream 202, e.g. which subscriber (or second streaming client device), or class of subscribers (or class of streaming client devices), is admitted to receive the personalization metadata 122 [e.g., public, reserved, only for some subscribers, only for the virtual friends, and so on].

The personalization metadata 122 may be in a file independent of the at least one audio stream 202 and/or in the file dependent (e.g., in the same file) of the at least one media stream.

The second streaming client device 10b, 10c may parse the personalization metadata 122 to retrieve device related personalization data [e.g. playback environment information (such as target loudness level or DRC settings, e.g., living room, mobile, noisy environment, full dynamic range), preferred dialog level settings, preferred language settings, and preferred accessibility settings (audio description, etc.)]. The metadata engine 130 is configured to apply the device related personalization data to the personalization options and/or personalization settings 132, e.g. by instructing the decoder or transcoder 40 to apply the new personalization settings 132 implied by the personalization metadata 122.

The at least one second streaming client device 10b may receive the at least one media stream 202 (e.g. synchronously) to the first streaming client device 10a, [and, in some examples, synchronously to at least one other second streaming client device 10c], and (e.g. in parallel), receive, from the streaming server system 20 (which and, in turn, from the first streaming client device 10a) or directly from the first streaming client device 10a, personalization metadata 122 associated with portions (e.g. already provided portions) of the at least one media stream 202. The personalization metadata 122 may be associated, as explained above, with portions of the at least one media stream 202, [e.g. the personalization metadata 122 may include timing information 142 of the already provided portions of the at least one media stream 202]. The metadata engine 130 [e.g. social media message processor] of the second streaming client device 10b, 10c may apply the personalization settings 132 obtained from the personalization metadata 122, [e.g. synchronously to the timing information].

In addition or as an alternative, the at least one second streaming client device 10, 10b, 10c may be such that the personalization metadata 122 include timing information 142 of the already provided portions of the at least one media stream 22, so that the metadata engine 130 applies the personalization settings 132 obtained from the personalization metadata 122 synchronously to the timing information 142.

In addition or as an alternative, at the reception of a personalization metadata 122 associated with already provided portions of the at least one media stream 202 [or at the verification of non-reception after a predetermined time span has elapsed], the second device 10b, 10c may transmit the reception acknowledgment or non-acknowledgment packet to the streaming server system 20 (or directly to the first streaming client device 10a) indicating the reception or non-reception of a personalization metadata 122 (see also above).

In some examples, at the verification of non-reception of a personalization metadata 122 associated with already provided portions of the at least one media stream 202, the second device 10b, 10c may transmit the reception non-acknowledgment packet to the streaming server system 20 (or directly to the first streaming client device 10a) indicating the reception or non-reception of a personalization metadata 122 (see also above).

In some examples, as explained above the second streaming client device 10b, 10c may evaluate whether the personalization settings 132 have been successfully applied or are applicable (e.g. by hardware and/or software compatibility), and may send an evaluation acknowledgment or non-acknowledgment packet to the streaming server system 20 (which will route the evaluation acknowledgment or non-acknowledgment packet to the first streaming client device 10a), or directly to the first streaming client device 10a, indicating the result of the evaluation.

The second streaming client device 10b, 10c may extract the personalization settings 132 from the personalization metadata 122 and to perform an evaluation [e.g. preemptive evaluation] on whether the personalization settings 132 match its capabilities, [in some examples, in case of positive result of the evaluation, the personalization settings 132 may be are actually applied and maybe an evaluation acknowledgement is sent to the streaming server system 20 (or, in some examples, directly to the first streaming client device 10a), and/or if in case of negative result of the evaluation, the personalization settings may be are not be applied and/or the playback is stopped and/or maybe an evaluation non-acknowledgement may be is sent to the streaming client device].

In some examples, the metadata engine 120 [e.g. social media message processor] of the second streaming client device 10b, 10c, may modify [e.g. through user's input and/or through the user interface] the personalization settings 132 obtained from the personalization metadata 122. In this way, the metadata engine 120 may generate [e.g. during a personalization session and/or in real time] subsequent personalization settings addressing subsequent personalization options. The communication interface 120 of the second streaming client device 10b, 10c may transmit, to the streaming server system 20, and/or to store, the subsequent personalization metadata 122 [e.g. in metadata packets and/or in PSMM] describing subsequent personalization settings 122 of the at least one media stream 202 [e.g. so that at least one second streaming client device can enjoy the personalization settings defined by the personalization metadata 122]. This will be explained subsequently (e.g. with reference to FIG. 6), but it is here anticipated that there may be strategies to prevent the subsequent (e.g. second) personalization metadata 122 generated by the second streaming client device 10b, 10c from colliding with the first personalization metadata 122 generated by the first streaming client device 10a. For example, the streaming server system (e.g. interactivity server) 20 may generate new personalization metadata 122 by combining the second streaming client device 10b, 10c with the first personalization metadata 122 generated by the first streaming client device 10a. This may be achieved, for example, by taking into consideration both the timing information 142 included in the first personalization metadata 122 (generated by the first streaming client device 10a) and the timing information 142 included in the second personalization metadata 122 (generated by the second streaming client device 10b, 10c), so as to apply the first personalization metadata 122 at a first time point indicated in the first timing information, and the second personalization metadata 122 at a second time point indicated in the second timing information. In addition or alternative, there may be a predefinition of a priority (prioritization), so that the new personalization information generated by combining the first and second personalization information 122 is obtained by choosing the personalization information with higher priority between the first personalization information 22 and the second personalization information 22, according to a predefined prioritization. The definition of the new personalization information may be carried out either by the streaming server system 20 or by one of the streaming client devices 10 (10a-10c).

In examples, the second streaming client device 10b, 10c may receive, e.g. from the streaming server system 20 (or, in some examples, directly from the streaming client device), further personalization metadata 122 describing personalization settings 132 e.g. addressing the personalization options 204, [e.g. both the personalization metadata 122 and the further personalization metadata 122 may include timing information 142 on the portions of the at least one media stream 202, each applying different settings to different time portions of the same at least one media stream 202]. The metadata engine 130 [e.g. social media message processor] of the second streaming client device 10b, 10c may be configured to apply the personalization metadata 122 to retrieve the personalization settings 132, and the further personalization metadata 122 to retrieve further personalization settings 132. In this way, it is possible to fuse together the personalization settings 122 from different streaming client devices and define further personalization settings (e.g. indicated in FIG. 6 in 611), using a synthesis technique, e.g. by mixing channels personalized through the personalization settings 132 with further channels personalized through the further personalization settings 132.

In addition or as an alternative, it is possible to receive, from the streaming server system 20 (and/or directly from another streaming client device), information regarding the presence of the personalization metadata 122 [e.g. in association with the request, from the steaming client device, of the at least one media stream 202, and/or in association to a suggestion, from the streaming client device, of the provision of the at least one media stream 202] [and, in some examples, also verify the authorization to obtain the at least one media stream].

In addition or as an alternative, it is possible to receive and decode [and/or transcode and/or render] the at least one media stream 202 according to first personalization settings [either generated internally, or obtained from a first personalization metadata]; switching to second personalization settings [either generated internally, or obtained from a second personalization metadata].

Therefore, it is possible to fuse together the first personalization settings and the second personalization settings, e.g. using a synthesis technique, e.g. by mixing first channels personalized through the first personalization settings with second channels personalized through the second personalization settings.]

It is to be understood that, in some examples, the distinction between the device of FIGS. 9 and 10 is only to show the distinction between the generator of the personalization metadata 122 and the receiver of the personalization metadata 122, but, in some examples, also the device 10b or 10c of FIG. 10 may generate personalization metadata 122 and send them (e.g., to the device 10a of FIG. 9).

It is now possible to understand that a user may define its personalization setting 132 (which may permit the generation of personalization metadata 122) in its client device 10a and may, subsequently, make use of them in a second time e.g., the personalization metadata 122 being stored and not necessarily being transmitted to other devices (see also below, use case 1).

It is also possible, in particular when the timing information 142 is enclosed in the personalization information 122, to have seamless handover from a device to another device during playback (see also below, use case 2). It is possible, for a user, to request the playback from a first device (e.g., the device 10a of FIG. 9) to a second device (e.g., the device 10b or 10c of FIG. 10), both being associated to the same user (e.g., based on the same subscription). The timing information 142 may refer to the exact position in time where the personalization settings have been applied. Even subsequently (e.g., when the user has migrated to the second streaming client device 10b or 10c of FIG. 10), the second streaming client device 10b or 10c (e.g., at the decoder 40) will perform a seamless continuation of the playback.

Another example is when the first user personalizes its content in FIG. 9, but provides the personalization metadata 122 to different users (which are associated to devices 10b, 10c, of FIG. 10) (see also below, use case 3). This can be, for example, when the user of the device 10a performs a remix of a particular stream. The receivers of FIG. 10 may, for example, receive personalization setting recommendations from the device 10a of FIG. 9, to guide the users of the devices 10b, 10c of FIG. 10 to choose the particular personalization suggested by the user of the device 10a of FIG. 9 (see also below, use case 4). It is also possible to share the personalization settings with other devices. This may be done, for example, by sharing in social media.

It is also possible to perform a real-time sharing of the same personalization settings 132. If the devices 10a, 10b, and 10c only receive the same stream 202 simultaneously, it is possible that the device 10a of FIG. 9 sends its personalization settings 132 (in the form of personalization metadata 122) to the devices 10b and 10c of FIG. 10 (see also below, use case 5).

It is also possible, for a device 10b, 10c of FIG. 10 to receive the personalization metadata 122 from the first communication device 10a of FIG. 9 and to personalize it a second time, so that a third device may receive the personalization metadata 122 first generated by the first device of FIG. 9 and subsequently modified by a second device of FIG. 10 ((see also below, use case 6).

FIG. 12 shows an example of a streaming server system (e.g., interactivity server 20). The streaming server system 20 may include or being connected to a repository 210. The repository 210 may include at least one of:
personalization option metadata (in prevision of being sent to the client devices, e.g. 10a, 10b, 10c)
personalization metadata 122 (e.g. as already provided by the first streaming client device 10a, e.g. in prevision of sending it to the at least one second client device 10b, 10c),
address identification (e.g. pointer) 123 (e.g., indicating e.g. in a uniquely fashion how and/or where to retrieve the at least one media stream 202), linking to a second repository 210′ of the second streaming server system 20′ (streaming content server system) different from the streaming server system 20 (interactivity server 20).

The personalization metadata 122 may be, for example, received from the first client device 10a. The repository 210 may also comprise a personalization option metadata (e.g., those provided to the streaming client device 10a in FIG. 9). The repository 210 may also comprise, for example, content identification 143, and/or an timing information 142, user information 145 and/or other information which is to be in the personalization metadata 122. For example, there can be address identification identifying the address for retrieving the stream 202.

It is to be noted that it is not necessary that the stream 202 is in the same streaming service system 20.

On the basis of the request 134 (or in some cases, independently), the streaming service system 20 may provide the personalization metadata 122 to the second client device 10b or 10c. A typical example of operation is:
1. Providing (in some examples, optionally) personalization option metadata 104 to the first streaming client device 10a
2. Providing the at least one media stream 202 to the streaming client devices 10a, 10b, 10c
3. Receiving the personalization option metadata 204 from the first client device 10a
4. (In some cases, sending recommendation information to the at least one second client device 10b, 10c regarding the possibility of receiving the personalization metadata 122)
5. Receiving a request 134 of personalization metadata 122 from the second client device 10b, 10c
6. Providing the personalization metadata 122 to the second client device 10b, 10c.

It is to be noted that the stream 202 may be provided to the first and/or second client device independently of the provision of the personalization option metadata 122 of the personalization metadata 122 and of the address identification for the stream 202.

As can be seen, there is a distinction between FIG. 11 and FIG. 12: while in FIG. 11 the media streams 202 are provided by the same streaming service system (e.g., interactivity server) 20, in FIG. 12 the streams 202 are provided by a second streaming server system 20′. In any case, the streaming server system 20 and the second streaming server system 20′ may form one single collective stream 202 in own single server system which may provide both the streams 202 and the personalization option metadata 204, the personalization metadata 122, and/or address identification 123 (e.g. pointer). It is to be noted, however, that in the example of FIG. 12, the streaming server system 20 and the second streaming service system 20′ may be independent of each other: in some examples, it may be that only the address identification links the streams 202 contained in the stream repository 210′ of the second streaming server system 20′ with the personalization option metadata 204, personalization metadata 122, and/or address identification 123 (e.g. pointer), and so on of the repository 210 of the streaming server system 220. It is also noted that the streaming server system 20 may comprise a communication interface 220 for performing the communications with the first and second client devices 10a, 10b, 10c (10). In the examples above, it is not shown that recommendation information may be sent from the first client devices 10a to the streaming server system 20 and that the streaming server system roots the recommendation information to the second client device 10b or 10c. Notwithstanding, this may be possible, and may also be a reason for triggering the request 134 from the second client device 10b or 10c to the first client device 10a through the streaming server system 20.

It is also to be noted that authorization information may be transmitted e.g. from the first client device (within the personalization metadata 122) to the second client device 10b or 10c through the streaming server system 20. This authorization information may include, for example, keys for decrypting a personalization metadata 122, for example, or other information that may be used for providing the personalization metadata 122.

It is also to be noted, in some cases, the second client device 10b or 10c can transmit an acknowledgement or non-acknowledgement information to the first client device 10a (either directly or through the streaming server system 20), indicating that the personalization metadata 122, when provided to the decoder or transcoder as personalization settings 132, have not been successful (or more in general, that the personalization metadata has not been received). The acknowledgement or non-acknowledgment may therefore be routed or transmitted to the first streaming client device 10a, so that the first streaming client device 10a may either provide an alarm to the user or automatically change the personalization metadata. This may be implemented, in the device 10a of FIG. 9, for example, by defining some first personalization metadata and some second personalization metadata with lower ranking with respect to the first personalization metadata, using the criterion that, in case the non-acknowledgement is received (and/or that no acknowledgement is received within a predetermined threshold time) then the second personalization metadata 122 (which low ranking) are transmitted to the second client device 10b or 10c (either directly, or through the streaming server system 20).

With reference to FIG. 6 (see also below) the streaming server system 20 may, in some examples, synthesize two different personalization metadata. For example, it may be that the first device 10a performs a first personalization (defining first personalization metadata) which is provided to a second device 10b which in turn modifies the personalization, generating second personalization metadata (or in some examples generates the second personalization metadata independently of the first personalization metadata). Here, the streaming server system 20 may
receive, from the second streaming client device (10b, 10c), second personalization metadata (122) associated with already provided portions of the at least one media stream (202), the second personalization metadata (122, 608b) including timing information indicating in which point of the at least one media stream the second personalization metadata (122) are to be applied; and
generate new personalization metadata (122) from the personalization metadata (122) generated by the first device 10a and the second personalization metadata (122, 608b);
transmit the new personalization metadata (122, 611) to first streaming client device (10a) and/or at least one further second streaming device and further second streaming device (10b, 10c).

This result may be achieved by generating the new personalization metadata (611) by combining together the personalization metadata (122) and the second personalization metadata (122, 608b) through the timing information (142) of the second personalization metadata (122) and timing information (142) of the personalization metadata (122).

In addition of alternative, the streaming server system 20 may generate the new personalization metadata (611) by deciding which of the personalization metadata, between the personalization metadata (122) and the second personalization metadata (122, 608b), are to be used for the new personalization metadata (611) based on pre-defined priorities.

In example above, reference is often made to a metadata engine 130 and a communication interface 120. It is noted, however, that these components may be implemented in one single device or unit, in some examples. Further, the metadata engine 130 may be a personalization engine, in some examples, which defines and/or processes at least one of personalization metadata, personalization option metadata, personalization options.

Here above, it is often referred to transmissions, e.g. between streaming client devices and/or between a streaming client device and one of more streaming server system(s). It is to be noted that at least some of the transmissions may be, for example, through a communication network (e.g. implying a geographical or local communication network), and/or through a social media environment (which may also imply the use of the communication network (in many examples, this would be the communication between the streaming client device and the streaming server system, or between differ streaming client devices through the streaming server system). Some of the transmissions may, however, be local: for example, the streaming client device may be connected to another streaming client device directly (e.g., through a wireless or wired direct local connection). However, in other examples, all the transmissions may be through the communication network, or more in particular through the social media environment (i.e. using the communication server system).

Therefore, examples above and below describe solutions for efficient devices, systems, methods and techniques in particular to personalise media and share the personalisation in a social media environment. Personalised social metadata messages may be defined for an efficient exchange of personalisation information. These metadata may allow to share personalisation of media playback, especially of next generation audio, between several media devices and network entities, like interactivity servers. This enables a connected, personalised media consumption experience for a group of users. Interactivity servers control the handling of the social media messages and their relationship to content media assets. Content providers can control the personalisation for every content asset and can add the connected, social personalisation service to their media infrastructure. Alternatively, social media platforms can offer a connected, social personalisation service independent of the media service.

Above and below there is disclosed, inter alia, a method for enabling a shared personalized experience amongst multiple media receiving devices, the method comprising at least one or a combination of or all of:
sending a media stream which contains metadata that can enable individual personalization options for each user on a media receiving device;
receiving the media stream by at least two independent media receiving devices;
at least one user interacting with the media content on at least one first media receiving device and applying his preferred personalization options to the content on the at least one first media receiving device;
efficiently sharing his media content specific and personalized settings from the at least one first media receiving device to the at least one second media receiving device, such that the at least one second media receiving device receives at least the media content, a content identifier, the personalization settings, synchronization information describing the time of each personalization setting change and control metadata describing the allowed interactivity and personalization settings;
the at least one second media receiving device applies the personalization settings associated with the media content and the personalization settings created on the one first media receiving device using the received synchronization information.

### Discussion

### Use Cases

The following use cases illustrate the application area for the proposed solution of social media metadata. The described scenarios start with single user use cases, followed by multi user use cases that differentiate in the complexity and kind of environment in which the social sharing aspect of personalization is handled.

The use case descriptions are ordered such that each of the outlined use cases adds another aspect that currently is not possible and is solved by the proposed solution. They cover a bundling of content and personalization metadata in one file, resp. package, (use cases 1, 2 and 3), as well as a separate sharing and exchange of personalization metadata that leaves the content asset files or streams untouched and unmodified (use cases 4, 5, and 6). The use cases 4 and 5 outline a complete architecture for sharing and exchanging personalization metadata in a social media context. On top of that, use case 6 adds the aspect of personalization recommendations for content genres or playback environments, in addition to the personalization related to specific content assets.

Use Case 1: Single User, Handover from One Device to Another Device

An end user consumes content on one device (e.g. the first streaming client device 10a of FIGS. 1 and 9) and personalizes the experience based on the options that are offered for the respective piece of content through the metadata (e.g. the personalization option metadata 204) that comes along with it, e.g. as part of the encoded bitstream (e.g. associated with the stream 202, either in the same file or in another file associated to the stream 202). The user then stops the playback on the first device 10a and wants to consume and potentially replay the same content at a later point in time on a second device (e.g. the streaming client device 10b or 10c of FIGS. 2 and 10) with the same personalization settings 132 for the complete content as on the first device.

This effect may be achieved, in particular, by the fact that the second device (streaming client device 10b or 10c) receives the personalization metadata 122 from the first streaming client device 10a through the streaming server system 20. Alternatively, the second device (streaming client device 10b or 10c) receives the personalization metadata 122 directly from the first streaming client device 10a, without a streaming server system 20 being involved.

Use Case 2: Single User, Seamless Handover from One Device to Another Device During Playout

This use case adds a dynamic, timing aspect.

Similar to use case 1, an end user starts to consume content on one device (e.g. the first streaming client device 10a of FIGS. 1 and 9) and personalizes it. The user then stops the playback on the first device 10a and wants to continue to play the same content on a second device (e.g. the second streaming client device 10b or 10c of FIGS. 2 and 10), starting at the exact position (time) where he stopped with the same personalization setting 132 that were applied at the “stop” point in the first device 10a. This continuation might happen after a break or pause, while the user switches to the other device 10b or 10c. Or the playback might be a seamless continuation while switching from one playout device (10a) to another (10b or 10c).

This effect may be achieved, in particular, by the inclusion (operated by the first streaming client device 10a) of the timing information 142 in the personalization metadata 122, which are then transmitted, through the streaming server system 20, to the second streaming client device 10b or 10c. Alternatively, the second device (streaming client device 10b or 10c) receives the timing information 142 in the personalization metadata 122 directly from the first streaming client device 10a, without a streaming server system 20 being involved.

Use Case 3: Multiple Users: One User to Share Personalized Content with Other Users

This use case adds the aspect of multiple users sharing personalized content.

An end user (e.g. at the first streaming client device 10a of FIGS. 1 and 9) consumes content (e.g. from the stream 202) and personalizes it (e.g. through personalization settings 132). He or she wants to share the personalization settings 132 with others, e.g., recommending them to consume this content with those settings and potentially add other useful information about those recommendations that might be helpful for users receiving those recommendations. He attaches the settings to the piece of content (or more in general associates the personalization settings 132 with the stream 202) and shares both together e.g. as one package (e.g. including the personalization metadata 122) with others. This package (e.g. 122) may contain more than one personalization setting 132 that apply to different points in time on the content time line. The sharing of the package can e.g. happen through any kind of social media, communication service or data service, for instance messengers, email, internet servers or data exchange platforms. This sharing could be either publicly to anyone that can have access to the same content, or privately to dedicated or invited users. Users (e.g. associated with the streaming client devices 10b, 10c, etc.) that pick up such a file 122 that includes personalization setting recommendations can then change the settings 132 to their preferences and add their recommendations in addition to the first ones back into the file 122.

One example for this use case is the following: A user creates a remix of an interactive song with the audio objects provided in the NGA bitstream. This newly arranged song is shared with followers, friends and fans. Interactive music can contain certain elements that can be changed within the mix and manipulated in gain and/or spatial perception. These interactions can be stored as metadata with timing information for frame accurate reproduction of the remix. This metadata can be shared with other listeners who can listen to the new mix.

Use Case 4: Multiple Users: One User to Share Personalization Settings with Other Users

This use case adds the aspect of decoupling content from personalization settings, and sharing the later independently using social media environments.

An end user (e.g. at the first streaming client device 10a of FIGS. 1 and 9) consumes content (e.g. from the stream 202) and personalizes it (e.g. through personalization settings 132). He or she wants to share the personalization settings 132 with others, e.g., recommending them to consume this content with those settings. There may be several personalization settings that apply to different points in time on the content time line. The end user shares only the settings 132 (e.g. in the personalization metadata 122) without the actual content assets (e.g. similarly to what happens in FIG. 12, the media stream 202 is not provided together with the personalization metadata 122). Multiple users can share their personalization settings for the same content asset.

The sharing can happen through e.g. any kind of social media, communication service or data service, for instance messengers, email, internet servers or data exchange platforms. Those methods are either directly aligned to or offered by the content service provider, or independently of those. This sharing could be either publicly to anyone that can have access to the same content, or privately to dedicated or invited other users.

### Use Case 5: Multiple Users, Sharing the Same Personalized Experience During Playback

This use case adds the aspect of realtime sharing of personalization settings for a connected, linear, personalized content consumption

An end user (e.g. at the first streaming client device 10a of FIGS. 1 and 9) consumes content (e.g. from the stream 202) and personalizes it (e.g. through personalization settings 132). One or more other users consume the same content (e.g. from the same stream 202) at the same time on their devices (e.g. the streaming client device 10b or 10c) at other locations. All those users are connected and in contact with each other during playback through any kind of communication method, e.g. text messengers, voice messages, voice conferencing services, or a social media platform that might be independent from or integrated into the content service platform. The users either manually started the on-demand streaming of the same content roughly at the same time, use a method that synchronizes the streaming and playout of the same content between them, or consume the same live streaming or broadcast event. The first user (using the first streaming client device 10a) now wants to share the personalization settings 132 with the one or more other users (using the streaming client device(s) 10b, 10c, etc.) so that they share the same personalized experience. During playback, in some examples, any of the users (using the second streaming client device(s) 10b, 10c, etc.) participating in this experience can change the settings 132 and those are transferred to the others so that they share this modified experience from this point onwards.

Therefore, the settings 132 may be once generated by the first streaming client device 10a, then modified by the second streaming client device 10b, so that both the first streaming client device 10a and a third streaming client device 10c have the playback with the same personalization settings 132 defined by the second streaming client device 10b.

### Use Case 6: Multiple Users, Sharing Personalized Experiences for Genres of Content

This use case adds the aspect of personalization recommendations on a more generic scope like content genres

An end user (e.g. at the first streaming client device 10a of FIGS. 1 and 9) or media sharing platform (e.g. at the first streaming client device 10a of FIGS. 1 and 9) provider creates a general setting 132 for the optimized playback of different content genres or for different listening environments. This setting 312 can then be shared with other users such as friends and family or users of a media delivery platform (e.g. 20, 20′) to allow for an easy adoption of these general settings 132. This functionality also enables content platforms (e.g. 20, 20′) to offer a certain/recommended playback setting 132 for different types of content and playback scenarios, for example music streaming into the car or to a mobile phone. Broadcast users with special needs can be provided with such general playback settings without the need that they go through all the settings 132 (e.g. from the personalization metadata 122) on their device (e.g. 10b, 10c) on their own.

### Proposed Solution and Requirements

Use case 1 may require the storage of the personalization settings 132, e.g. together with content identifier 143 and/or synchronization information in a metadata structure (e.g. in the personalization metadata 122) and then subsequently e.g. in a file or delivery format structure. A metadata packet (e.g. including the personalization metadata 122) may be defined that is derived from the user interface settings. This metadata packet may be a description (e.g. full description) of the current state and may enable the creation of a user interaction event packet 340 on the receiving device 10b, 10c (see FIG. 2) that leads to the same personalized playout as it has been the case before on the first device 10a.

In addition to the solution for use case 1, timing information 142 may be required in the personalization settings metadata packet (122) for use case 2. This timing information 142 in this metadata packet (122) may refer to the point in time on the time line of the content where the user stopped the playback on device 1 (10a). This time line information of the content can for instance be the timeline information in the mp4 content file or the time line of the content stream 202.

Use case 3 may require the solution from use case 2 and in addition the ability to add more than one preferences metadata packets (122) to the same content file (202) that can be uniquely identified. It also could contain information generated by the sharing user giving some description, explanation, messages or tags added to the settings that may inform the receiving users about the context of the settings or give them any other useful information about the recommendations.

Use case 4 (e.g., FIG. 12) may require the solution of use case 3 and in addition an e.g. complete and/or content identification 143 and/or unique content asset identification 123 (e.g. pointer), as the personalization settings 132 (e.g. as written in the personalization metadata 122) are separate from the content asset (e.g. stream 202) they refer to. This content asset identification 123 (e.g. pointer) may need to include information how to access the content source, for instance streaming links to the content or information about the streaming content service provider 20′. This use case 4 may require user identification 145 to be part of the preferences metadata packet (122) to differentiate the preferences of several users. This use case 4 may also require access or restriction information about who (and which streaming client device) is eligible to access the preference recommendations. This includes, for instance, information if those recommendations are for open, public usage or for private usage, including potential information which users are supposed to have access to the preferences settings. This use case also requires packaging the preference settings into an independent file, packet or stream, and further, methods to enable file exchange of the preference metadata packets between the users, or to enable the usage of existing download or file sharing methods for those packets, for a direct exchange between users or through network entities like internet servers that manage this exchange.

Use case 5 may require the solution of use case 4 and in addition e.g. information to enable synchronized playback of the content from the same source in all devices 10a, 10b, 10c of the participating users. In contrast to use case 4, this use case may require a low latency solution to share the preference metadata packets (122) and potentially a feedback channel between all users so that the user (or the client device 10a) sending the preference settings 132 (in personalization metadata 122) gets an acknowledgment about the reception and/or if/when the settings have been applied at the reception ends. This may also be important to enable alignment of the playout of all participating users, especially if more than one users changes some personalization settings 132 during playout.

Use case 6 may require additional information as part of the personalization settings 132 (as written in the personalization metadata 122) to identify, for instance, the content genre or the intended listening environment. Information such as a genre identifier and a listening environment identifier may need to be transmitted together with the content identifier. This information enables playback devices to apply the personalization settings only to content that is matching the genre in listening situations it was intended for.

### Examples According to the Present Techniques

### Generic Solution Description

The present document describes a solution for efficient methods to personalize media and to share the personalization e.g. in a social media environment. It fulfils all requirements that are outlined in the section “Proposed Solutions and Requirements” above and enables all or at least some of the use cases that are outlined in the “Use Cases” section above.

Personalized Social Media Messages may be defined in the form of metadata (e.g. being or carrying the personalization metadata 122) for an efficient exchange of personalization information and/or of personalization settings 132. Aim of this metadata 122 is to share personalization of media playback, especially of next generation audio, between several media devices and interactivity servers. This enables a connected, personalized media consumption experience for several users.

In one example, the Social Media Message Processor 110 (e.g. for personalization metadata 122) in the media receiver (e.g. 10a) captures the personalization settings 132 to generate a social media message (e.g. 122), and/or receives the message 122 in other media receivers (e.g. 10b, 10c) to regenerate and/or adapt the personalization settings 132.

In the same or in another example, Interactivity Server(s) (e.g. streaming server system(s) 20) may control the handling of the social media messages and their relationship to content media assets (e.g. stream 202) and the exchange of messages between all involved media receivers (e.g. 10a, 10b, 10c).

In the same or in a different example, content providers can control the personalization for every content asset through Social Media Control Messages and the respective infrastructure of media servers, interactivity servers and user control and authentication servers that enforce the usage of the control messages and the personalized social metadata messages.

In the same or in an alternative example, social media platforms can offer a connected, social personalization service independent of the content media service, i.e. for content that is not bound to one content streaming service.

In the same or in a different example, the content is provided in the form of a media bitstream (e.g., video and audio, audio only, etc.) 202 over existing common broadcast (e.g., ATSC 3.0, DVB, ISDB, etc.) and broadband networks (e.g., streaming over DASH, HLS, CMAF, etc.). The content contains already a set of personalization options (e.g., dialog enhancement, different presets, etc.) and from a single bitstream each user can personalize the content within the limits imposed in the media stream 202.

In the same or in a further example, the content providers or social media platform providers can offer Personalization Recommendation Messages not only for single content assets, but for sets of content or content genres or listening environments. Interactivity servers can handle the relationship of those recommendations with different kinds of content assets and codec or media types. As part of an interactivity server or media receiver a Personalization Recommendation Mapper identifies which recommendation relates to what content assets and how the personalization recommendations can be mapped to a given content asset in its respective form (i.e. media type or codec type in use).

Description of Entities for Personalized Social Media (e.g. being and/or Carrying “Social Media Control Data”, and/or being and/or Carrying “Personalization Option Metadata”)
Social Media Control Message (e.g. being and/or Carrying “Social Media Control Data”, and/or being and/or Carrying “Personalization Option Metadata”)

The Social Media Control Message (SMCM) (e.g. being and/or carrying “Social Media Control Data”, and/or being and/or carrying “personalization option metadata”) may enable and/or control a multi-user personalized experience. The SMCM is embedded into the content media asset (stream or file). It may describe what the content provider (e.g. 20 in FIG. 11 or 20′ in FIG. 12) allows and enables with regard to a personalized social media experience with the content media asset.

The SMCM metadata may be bound to the content asset (e.g. stream 202) and/or can be embedded at elementary stream level, for example into MHAS packets for the MPEG-H Audio format; at mp4 file format level, for example into a file format box; or in newly defined metadata boxes. The SMCM metadata may contain amongst others, additional information required for:
enabling the users to send and receive personalization settings amongst themselves
controlling the receiving devices and correctly applying the personalization settings during media rendering
restricting the sharing capabilities for certain user categories (e.g., only premium users with a paid subscription can share their personalized experience or receive personalized experiences from others)

The Content Media Identifier within the SMCM may provide information about the content that is relevant for a connected, personalized social media experience. This includes a unique media identifier to enable all entities within a personalized social media environment, such as the media receivers, interactivity servers and content servers, to link content media assets (files, streams) to the respective social media messages. Thus, media receiving devices with multi-user personalization capabilities are enabled to correctly identify and apply the personalization settings in a multi-user environment. For that reason, the same identifier is also embedded into the personalizationSocialMediaMetadata( ) described below.

Note, that the unique content identifier can also be delivered at different locations in the content file or stream for certain examples or codecs, like on mp4 file format level or elementary stream like (e.g., an MHAS packet in case of MPEG-H 3D Audio). Such a content ID is then aligned to the ID in this message.

The allowSharedExperience attribute within the SMCM may provide the indication that the current media stream allows a shared experience and based on its value, different capabilities are enabled:
No sharing capabilities allowed
Fixed sharing capabilities allowed (e.g., recommendations provided by a third-party entity/interactivity server)
Single-user sharing allowed (e.g., one user can share its personalization and invite others to experience his settings. All other users will not be able to share in the same time)
Multi-user sharing allowed in a group (e.g., Every user registers to a selected group and jointly share their settings which are than applied to the entire group)

One or more User Categories are defined within the SMCM defines the number of user categories. Each user category can be uniquely identified and described through a User Category Feature Set. A set of features and/or restrictions define how a user that is part of a specific category can experience the shared personalization settings. For example, each user has a social media account with different rights and only premium user accounts that are associated to a specific user category can enable such multi-user personalization capabilities.

Personalized Social Media Message (e.g. being and/or Carrying Personalization Metadata)

The Personalized Social Media Message (PSMM) (e.g. being and/or carrying personalization metadata 122 as sent by the device 10a to the devices 10b and 10c through the streaming server system 20) may comprise (e.g. consist of) information that may be necessary to enable a multi-user personalized experience. The PSMM 122 may either be embedded into the content media asset (stream or file) (e.g. in FIG. 11) or encapsulated into a separate file (e.g. in FIG. 12) for exchange of information between the entities involved in a shared personalized social media experience, including media receivers as generators (e.g. 10a in FIGS. 1 and 9) and/or receivers (e.g. 10b, 10c in FIGS. 2 and 10) of such messages or network entities such as the interactivity server (e.g. 20 in FIG. 11), content media servers (e.g. 20′ in FIG. 12) and/or user authentication servers.

The PSMM 122 may describe a specific personalization event to be shared and may include all (or at least some of the) necessary (or at least useful) information to describe the personalization (e.g. 132) and to uniquely link the message to the respective content asset. A PSMM message 122 may comprise (e.g. consists of) at least one of the following sets of information:
PSMM identification information,
content identification information (e.g. 143),
current media position information (e.g. timing information 142),
content related personalization data,
environment or device related personalization data, and
user related information (e.g. 145).

The PSMM identifier may include at least a (e.g. unique) PSMM message identifier, a (e.g. unique) PSMM creator information, and a (e.g. unique) PSMM creation time.

The content identification information (e.g. 143) may comprise (e.g. consist of) at least an Universally Unique IDentifier to identify the content to which the message belongs, content genre information, content access information (e.g. a link to the content asset file or stream 202, e.g. in the example of FIG. 11), and/or content description information, e.g. including genre information.

The current media position information may comprise (e.g. consist of) at least media timebase related information to enable different PSMM 122 to be applied at different positions within the content, and to enable a synchronized personalized playback experience of several playback devices (e.g., devices 10, 10b, and 10c being synchronized with each other).

The content related personalization data may comprise (e.g. consist of) at least the media time at which the personalization data (e.g. personalization settings 132) should be applied (e.g. timing information 142), a media time until which the personalization data is valid (can be also implicit signaled), codec dependent personalization data, a description of the personalization, and/or a personalization version tag.

The environment or device related personalization data may comprise (e.g. consist of) at least of playback environment information (such as target loudness level or DRC settings, e.g., living room, mobile, noisy environment, full dynamic range), preferred dialog level settings, preferred language settings, and preferred accessibility settings (audio description, etc.).

The user related information (e.g. 145) may comprise (e.g. consist of) at least of the user identification that is the source of personalization information (122), access information, like “public access” or “closed access”, and/or recipient information, like who is allowed to access it (e.g. which client device 10b, 10c, etc. is allowed to access it).

Social Media Message Processor (Including the Metadata Engine 130 and, in Some Examples, Also the Communication Interface 120)

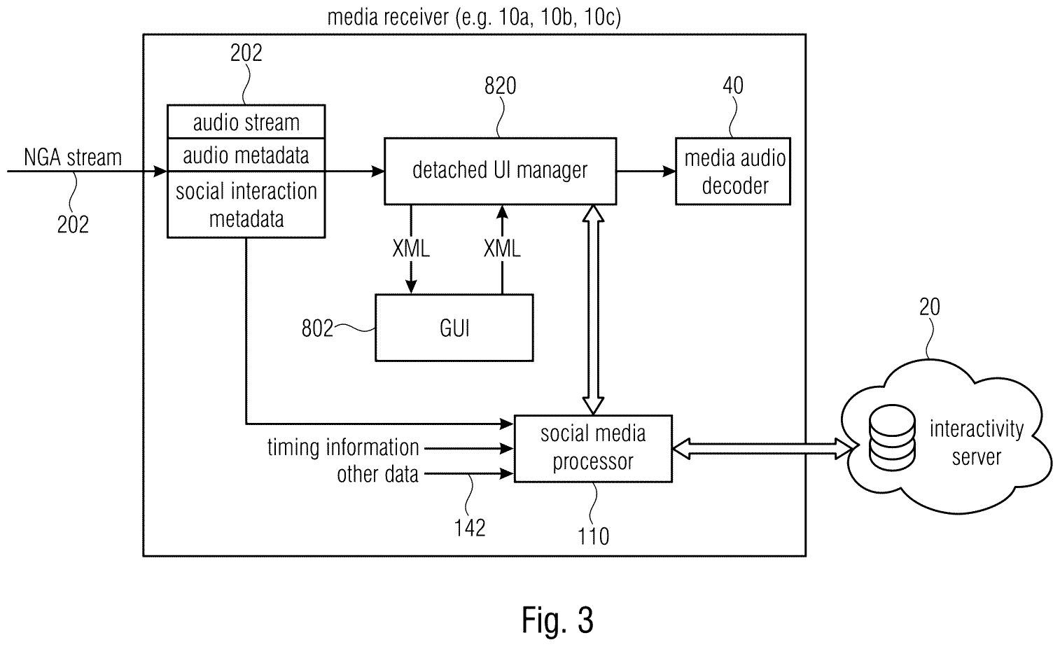

The media receiver contains amongst others, a Social Media Processor (including the metadata engine 130 and, in some examples, also the communication interface 120) or a Social Media Message Processor in a different example or in a different denomination) that can act as a receiver (e.g. FIGS. 2 and 10) and/or as a generator (e.g. in FIGS. 1 and 9) (or a Social Media Message Generator in a different example). FIG. 1, 2 and FIG. 3 show a Media Receiver for multi-user personalization (which may be an example of the streaming client device 10a, 10b, or 10c) which provide simplified architecture examples of a media receiver embedding a Social Media Processor.

The Social Media Processor (e.g. metadata engine and/or communication interface) may be responsible to perform at least one of the following functions:
Receive information about the Social Media Control Message Data available in the media stream or file
Receive information about the user interactions on current device (e.g. 10a, 10b, 10c)
Receive timing information and other data from the media receiver system layer required to accurately time-stamp any user interaction
Generate a Personalization Social Media Message 122 and embed the personalization information (personalization settings 132) and timing information (142)
Receive a Personalization Social Media Message 122 from the Interactivity Server.
Parse a Personalization Social Media Message 122 and embed the personalization settings to be applied into corresponding messages according to the media system in use
Process the timing information of the Personalization Social Media Message and of the local timing of the content played out locally on the media receiver.

The Social Media Processor 110 (e.g. metadata engine 130 and/or communication interface 120) in an example and/or operation as a Social Media Message Generator (e.g. in FIGS. 1 and 9) may perform at least one of the following functions, as shown in an architecture example in FIGS. 1 and/or 9:
Receive information (e.g. in the personalization option metadata 204) about the content, specifically from the Social Media Control Message available in the media stream 202 or file
Receive information (e.g. in the personalization option metadata 204) about the user interface state of the media receiver device
Receive information (e.g. in the personalization option metadata 204) about the device state of the media receiver device
Receive timing information and other data (e.g. in the personalization option metadata 204) from the media receiver system layer required to accurately time-stamp any user interaction
Receive other information (e.g. in the personalization option metadata 204) from the media receiver device, for instance user information, that is relevant for the social media message
Generate a Personalization Social Media Message (e.g. being and/or including the personalization metadata 112) and embed all or at least some of the mentioned personalization information and timing information
Encapsulate the PSMM into a metadata and file format using the PSMM Metadata Writer using a format as required for the example of the social media environment
transmit the PSMM to the PSMM Interactivity Server (e.g. 20) or directly to other media receivers, depending on the example of the social media environment

The Social Media Processor 110 (e.g. metadata engine 130 and/or communication interface 120) in an example and/or operation as a Social Media Message Processor (Parser, receiver) may perform at least one of the following functions, as shown in an architecture example in FIGS. 2 and/or 10:
Receive a Personalization Social Media Message (e.g. being or comprising personalization option metadata 204) from the Interactivity Server (e.g. 20)
Alternatively or in addition, receive a Personalization Social Media Message (e.g. being or comprising personalization option metadata 204) from the media content file, in the case the PSMM is embedded in the content, or receive the PSMM directly from another media receiver
Parse the PSMM metadata (e.g. being or comprising personalization option metadata 204) and/or file encapsulation using the PSMM Metadata Reader
Parse the attributes of the Personalization Social Media Message (e.g. being or comprising personalization option metadata 204) as extracted by the PSMM Metadata Reader
Parse the PSMM (e.g. being or comprising personalization option metadata 204) and/or the content identifiers to detect if the message applies to the currently consumed media, and check the user information
Check how the personalization attributes relate to the capabilities of the device, taking into account the personalization as supported by the media receiver and the codec in use, and perform a decision process in case the device does not fully support all personalization features
If the message is valid for the current media consumption scope according to the previous check, apply the personalization settings from the PSMM attributes according to the media system in use, including
instruct the UI manager 820 to set the user interface state accordingly
instruct the UI manager 820 to set (temporarily) the device state accordingly
use the information from the attributes to apply it to any other respective element in the device accordingly
Process the timing information from the PSMM and the local timing of the content played out locally on the media receiver.
From the instructions to the UI manager 820, the graphical user interface is updated accordingly to inform the user of the UI state 149 changes and at the same time the information is forwarded to the decoder to apply the personalization to the audio output. The later might happen through a direct interface to the decoder or an instruction set (like a user event or user interaction packet) that is embedded into the bitstream for further delivery to the decoder
   PSMM Metadata Writer (e.g. Part of the Communication Interface 120 and/or the Metadata Engine 130)

The PSMM Metadata Writer may be an entity configured to encapsulate the message that is generated by the Social Media Message Processor (e.g. in the metadata engine 130) into a delivery format (file or stream) for further distribution to other entities within a personalized social media environment. For different examples and/or different application areas, this encapsulation may appear at different levels, like elementary stream level, i.e. within the bitstream for instance as a data packet, at file format level, for instance within the file format header in case of an ISO/mp4 based file format or another file format level container or box, or as an independent file or packet for streaming delivery.

In different examples the message may be encoded (or instantiated) in binary form (e.g., for bitstream delivery or within an ISO/mp4 file format box) or in textual form, for instance as XML descriptor or JSON message.

In some examples the message is bundled with the content media file, i.e. either within the elementary stream or at file format level, or within the content media stream.

In other examples the message is encapsulated in separate, standalone files or stream packets for file exchange server upload or any other exchange mechanism within a personalized social media environment.

### PSMM Metadata Reader

The PSMM Metadata Reader (which may be part of the communication interface 120 and/or the metadata engine 130) may receive the PSMM (e.g. being or comprising personalization option metadata 204) through any delivery method, like file or stream packet, from e.g., an interactivity server (e.g. 120) or another media receiver. In different examples it reads the message either from a content file or from any other encapsulation method that the PSMM metadata write might have been used. The PSMM metadata reader then parses the message and forwards it to the Social Media Processor for processing the message.

PSMM Interactivity Server (e.g. Streaming Server System 20)

The Interactivity Server (e.g. streaming server system 20) may be a central entity in the architecture of a connected social media content experience. It handles the relationship between social media messages and content assets and handles the exchange, transfer and delivery of those messages. It also handles the relationship between all involved parties, including media receivers, content servers, user management servers, user authentication servers or social media platforms.

The Interactivity Server (e.g. streaming server system 20) may be responsible to perform at least one of the following functions (when it is referred to “users”, reference is basically made to their streaming client devices):
Authenticate users and grant access to specific personalization options based on user categories
Store a database of all content social media identifiers that have been created for specific applications.
Link to one or more social media platforms
Send and receive user invites to specific groups sharing the same experience
Establish a relationship between users based on the user access information in the social media messages and the user information from the user management and authentication servers
Receive Personalization Social Media Messages (e.g. being or comprising personalization option metadata 204) from one or more users
Send Personalization Social Media Messages (e.g. being or comprising personalization option metadata 204) to one or more users
Prioritize the Personalization Social Media Messages (e.g. being or comprising personalization option metadata 204) based on various criteria, including the user category
Create the Personalization Social Media Messages (e.g. being or comprising personalization option metadata 204) based on information received from one or more users and generate the timing information required for alignment of the personalization settings across all users that participate in the multi-user experience.
Combine multiple Personalization Social Media Messages (e.g. being or comprising personalization option metadata 204) received from multiple users into a single new Personalization Social Media Message and share the new Social Media Message (e.g. being or comprising personalization option metadata 204) with all users
Synchronize the exchange of personalization social media messages and content media time lines for the case of linear or live content media, like broadcast content or live streaming, including the alignment of user events and messages.
Organize the exchange of Personalization Recommendation Messages between content providers or social media platforms and media receivers.
Act as Personalization Recommendation Mapper to map and adapt the recommendations to specific content assets or specific media receivers or user preferences.
Generate specific Personalization Social Media Messages from Personalization Recommendation Messages after such a mapping process.

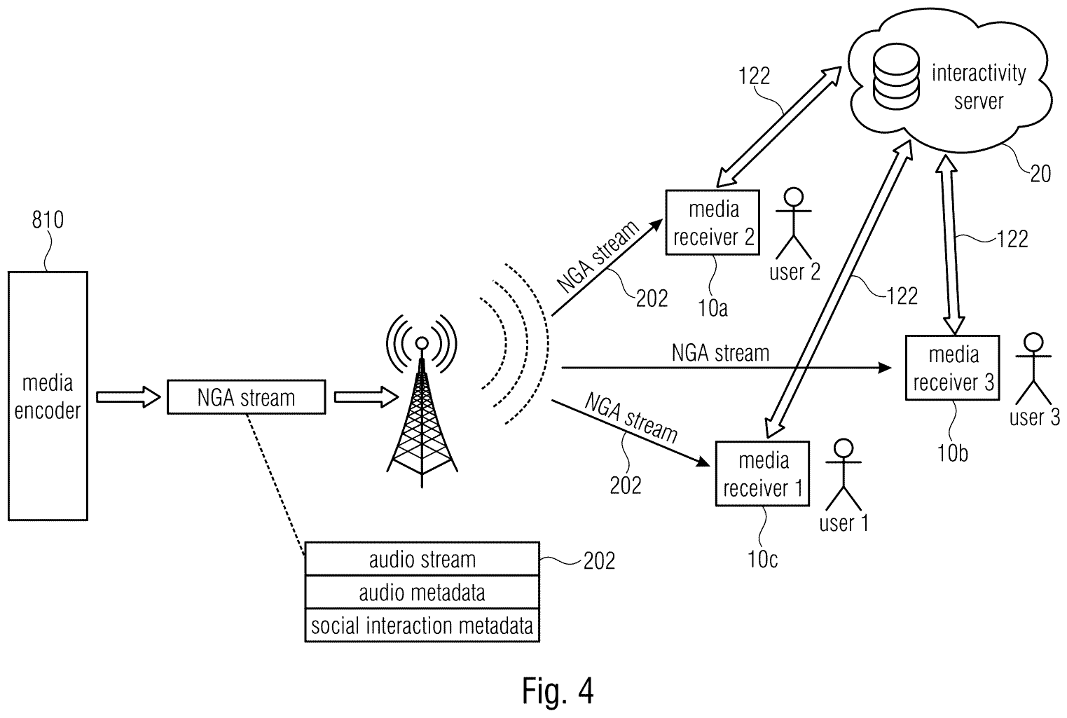

One example of an architecture around the Interactivity Server is outlined in FIG. 4 (a media encoder 810 being shown to provide the at least one media stream 202; in this example, the media encoder 810 may be at the side of the second streaming system 20′ in FIG. 12, separated from the interactivity server 20). All users are connected via the internet to an Interactivity Server (e.g. 120) which may therefore be responsible of controlling the shared personalized experience. This example shows a multi-user personalization environment for content distributed over broadcast/broadband connections and provides an example where multiple users receive the same media stream. The Interactivity Server (e.g. 20) can be an open server or a server provided by the social media application where all users are authenticated and uniquely identified. Each user may be using a media receiver (e.g. 10a, 10b, 10c) capable to receive the at least one media stream 202 and apply personalization options (e.g. personalization settings 132 obtained from the personalization metadata 122). That means that the device 10a, 10b, 10c may contain a media decoder and/or transcoder 40 and a user interface, for example a graphical user interface (GUI) 802, a voice-controlled interface, etc.

### Personalization Recommendation Message

The Personalization Recommendation Message (PRM) may comprise (e.g. consist of) information to describe personalization recommendations for sets of content, content genres or listening environments.

A PRM message may comprise (e.g. consist of) information that is necessary (or at least useful) and sufficient (totally or partially) to instruct media receivers how to personalize the content playback experience in a given listening environment for a specific user. The information also needs (at least in some examples) to be sufficient so that it can be mapped to PSMM messages for specific content assets.

Thus, the PRM contains at least the following sets of information:
PRM identification information,
content and content genre identification information,
user group information,
content related personalization data,
listening environment information
playback environment and device capability information, and
user group and user related information.

In some examples, the Personalization Recommendation Message may be or comprise personalization option metadata. In other examples, the Personalization Recommendation Message are not or do not comprise personalization option metadata 204. In some examples, the Personalization Recommendation Message is generated by the streaming server system 20. In other examples, the Personalization Recommendation Message is generated by a streaming client device and is transmitted to another streaming client device (e.g. either directly or through the streaming server system 20).

### Personalization Recommendation Mapper

The Personalization Recommendation Mapper may be part of an Interactivity Server (or more in general of a streaming server system), another network entity, or a media receiver, and derives recommendations from PRM messages to adapt the content playback of a certain media assets on a given device and environment for a specific user. Alternatively, one or more PSMM messages are derived from a PRM for further distribution, delivery and usage.

The PRM is responsible to perform at least one of the following functions:
parse and interpret the information from one or more PRMs,
decide how to apply the recommendations from one or more PRMs to a specific content asset, media device, playback environment, user, or a combination of all of those.
map the recommendations based on this decision to certain personalization settings
as part of the decision and mapping process: use a certain logic, e.g., a best-effort logic, if no 1-to-1 match is possible between the recommendation and the capabilities of a certain playback or device environment
for instance, in the case that a codec is used, such as a next-generation-audio codec, those metadata framework is less sophisticated, certain recommendations might need to be simplified
an example for such a simplification is a dialog enhancement recommendation for a specific dB value in a certain range, and the codec supported by the target media receiver only supports dialog enhancement on a coarser scale that does not match exactly the given recommended value
in the case that the PRM resides inside a media receiver, instruct the Social Media Processor to adapt those derived personalization settings, for instance as if they would origin from a PSMM
in the case that the PRM resides inside an Interactivity Server, create one or more PSMM for further usage by the Interactivity Server, for instance the delivery to media receivers

### Description of Events Towards a Personalized Social Media Experience

One User Shares Personalization with Other Users

As an example, there is a group of three users that want to share a personalized media consumption experience using a content media and social media platform. One user (10a) has a user category which allows sharing of his personalization settings (User 1) while the other users have a user category which allows them to only receive Social Media Messages (Users 2 and 3).

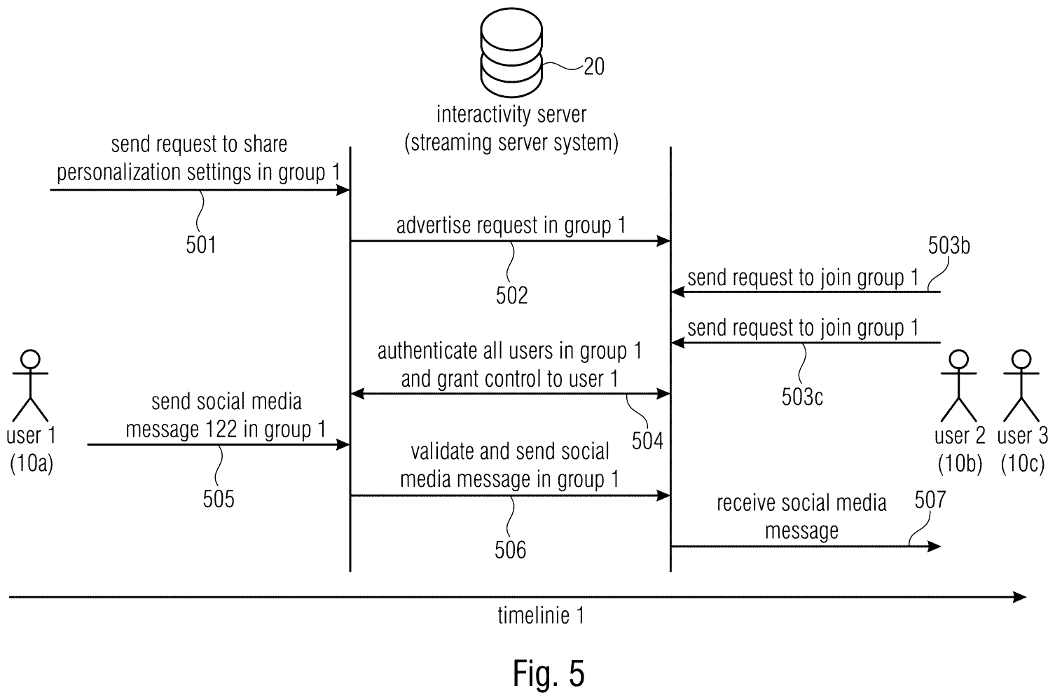

FIG. 5: Timeline 1 provides an illustration of the events handled by the Interactivity Server 20. It shows:
1) The first streaming client device 10a (e.g. of FIGS. 1 and/or 9) sends (to the streaming server system 20) a request 501 to share personalization settings 132 with second streaming client devices 10b and 10c (e.g. in the same group 1)
2) The streaming server system 20 (interactivity server) routes the request 501, e.g. through an advertisement 502 to the second streaming client devices 10b and 10c
3) The second streaming client devices 10b and 10c, after having received the advertisement 502 (and e.g. after having proposed to the user though their GUIs after that the user has accepted the suggestion through an input in the GUI) transmit the requests 503b and 503c, respectively, of joining the group 1
4) At 504, the streaming server system 20 (interactivity server) authenticates the streaming client devices 10b and 10c and/or informs (not shown in FIG. 5) the streaming client device 10a that it has control of the group 1
5) The streaming client device 10a sends the PSMM (personalization information 122) at 505 to the second streaming client devices 10b and 10c (507) through the streaming server system 20 (506) (e.g. the personalization information 122 is sent to the streaming server system 20, which in turn routes the personalization information 122 to the second streaming client devices 10b and 10c).

### Multi-User Shared Experience

In another example (or in another operation of one of the examples above), all users have a user category which allows sharing of their personalization settings (User 1, streaming client device 10a).

FIG. 6: Timeline 2 provides an illustration of the events which may be handled by the Interactivity Server (e.g. streaming server system 20). In this example the User 1 (streaming client device 10a) is requesting to start a shared user experience, but in other examples the Interactivity Server 20 can start such a shared user experience and advertise it amongst the users.

In the case when multiple users are allowed to interact with the same content (e.g. stream 202), the Interactivity Server 20 may prioritize the received Social Media Messages (e.g. personalization information 122) based on various factors, including but not limiting to:
Timing information (e.g. 142) of each Social Media Message (122)
Source and User category associated with each Social Media Message (122)
Content of the Social Media Message, for example if one user is increasing the dialog level with 3 dB and a second user is increasing the dialog level with 12 dB, the Social Media Message of the first user may be ignored and only the changes corresponding to the second user may be applied

Additionally, the interactivity server may parse all received Social Media Messages 122 from multiple users (10a, 10b, 10c) and combine the effects of all Social Media Messages 122 into a new Social Media Message. The process to combine the information into a single message can be done based amongst others on:
a defined set of rules,
user category of each user sending a Social Media Message
importance of each change contained in a Social Media Message.
Artificial Intelligence algorithms that can learn the behaviour of the users in the group and create decision rules based on the overall group behavior

An example in FIG. 6 is:
1) The first streaming client device 10a (e.g. of FIGS. 1 and/or 9) sends (to the streaming server system 20) a request 601 to share personalization settings 132 with second streaming client devices 10b and 10c (e.g. in the same group 1)
2) The streaming server system 20 (interactivity server) routes the request 601, e.g. through an advertisement 602 to the second streaming client devices 10b and 10c
3) The second streaming client devices 10b and 10c, after having received the advertisement 602 (and e.g. after having proposed to the user though their GUIs, and after that the user has accepted the suggestion through an input in the GUI) transmits the requests 603b and 603c, respectively, of joining the group 1
4) At 604, the streaming server system 20 (interactivity server) authenticates the streaming client devices 10b and 10c and/or informs (not shown in FIG. 6) the streaming client device 10a that it has control of the group 1
5) The first streaming client device 10a sends a PSMM 1 (first personalization information 122) at 605a to the second streaming client devices 10b and 10c (607b, 607c) through the streaming server system 20 (606).
6) At least one of the second streaming client devices 10b and 10c sends its own personalization information 122 (e.g. the second streaming client devices 10b and 10c send each a PSMM 3 (608b) and PSMM 5 (608c)
7) At 609, the streaming server system 20 may prioritize the personalization information 122 between the PSMM 3 (608b) and the PSMM 5 (608c)
8) At 610 (which may be before, after or in parallel to 609) the streaming server system 20 may combine the PSMM 3 (608b) and the PSMM 5 (608c) onto one single PSSM 6 (or more in general one single personalization information 122) based on the timing information 122.

Before the transmission of the request 601 by the first streaming client device 10a, the first streaming client device 10a may receive, in some examples, personalization option metadata 204 e.g. from the streaming server system 20, so that the first streaming client device 10a may define its personalization settings 132 to address the personalization options enabled by the personalization option metadata 204. In other examples, this is not strictly necessary.

Notably, however, the advertisement 602 may, in some examples, also be or comprise or be associated with personalization option metadata 204, which are then provided to the streaming client devices 10b, 10c. Therefore, the streaming client devices 10b, 10c may operate like the streaming client device, and their personalization metadata may be transmitted with messages 608a and 608b.

### Solution Examples for MPEG-H 3D Audio

### Creation of PSMM

As described above, a UI Interaction packet is created in the moment in time when the user changes something in the UI during playback to capture the user personalization request. This packet can then be inserted at the current position into the MHAS bitstream to be forwarded to the decoding stage. The personalization request from the packet is then applied by the MPEG-H 3D Audio decoder during the decoding and rendering process so that the user can experience the result of his personalization request during playback.

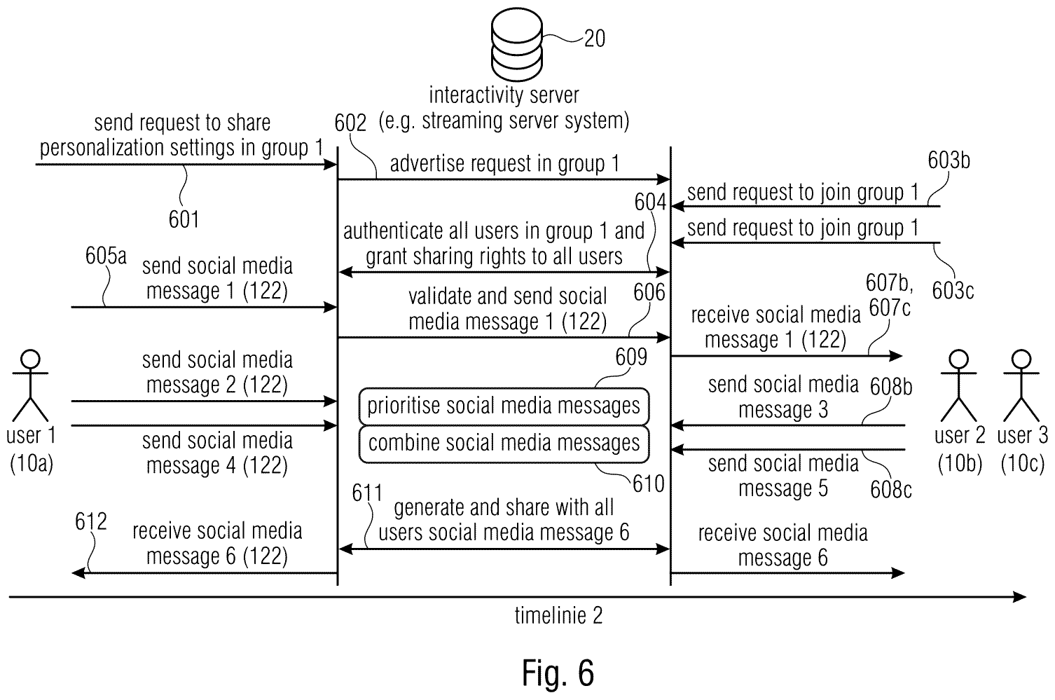

FIG. 7 shows how a Social Media Message Generator (e.g. 10a) can be embedded into a media receiver for MPEG-H 3D Audio.

To capture the current state of personalization (UI state 149, device state, information about timing 142, content, environment, user, etc.) for a later replay of the same content on other devices or sharing the state of personalization with other users, for immediate or later usage, a personalization social media metadata (PSMM) message is created.

Several methods to encapsulate a PSMM message are available, which one to use depends on the use case.

For the use cases 1, 2 and 3 the PSMM is stored in the content file. It is either inserted into the MHAS bitstream and thus encapsulated into a file format sample, or written to the file header, e.g., in the sample entry, or amended to the end of the file (e.g. in a user data box).

For bitstream encapsulation, the PSMM is encapsulated in a MHAS packet that is written at the current position (in terms of playback timeline) into the MHAS bitstream samples into the mp4 file. However, as this PSSM MHAS packet is part of the bitstream and thus of a file format sample, adding this packet would require a rewrite of the mdat box in the mp4 file, at least from this time position onwards, and requires a rewrite of tables in the file format header (moov) that potentially changes the length in bytes of the moov header.

Therefore, as a second option, adding the PSMM into the file format header encapsulating it into a PSSM box may be beneficial for some use cases. This method would not touch the mdat box and only requires a rewrite of the header.

A third option that completely avoids rewriting of the mp4 file may be even more beneficial more some use cases. For this option the PSMM is encapsulated in a PSMM box and added to a “user data box” that is amended to the file at the end of the mp4 file. Thus, the existing mdat an moov boxes are not touched at all. This also avoids the need to rewrite the tables in the file header.

### Relationship of UI Interaction Packet and PSMM Packet

A UI interaction packet, as defined in the MPEG-H 3D Audio specification, can capture a request of the user to change certain aspects of the personalization options that are enabled for the currently played back content. It was not intended and designed to capture the full state of the UI and personalization settings, nor is it capable to include the preferred user settings, for instance preferred language or dialog enhancement settings or any other personalization settings. Preferred user settings, for instance, are typically set on device level and automatically applied by the device during playback.

In contrast to the UI interaction packet, the newly defined PSMM packet captures the full state of UI settings and device settings, (etc) and thus includes more information compared to the UI interaction packet.

### Apply PSMM During Playback

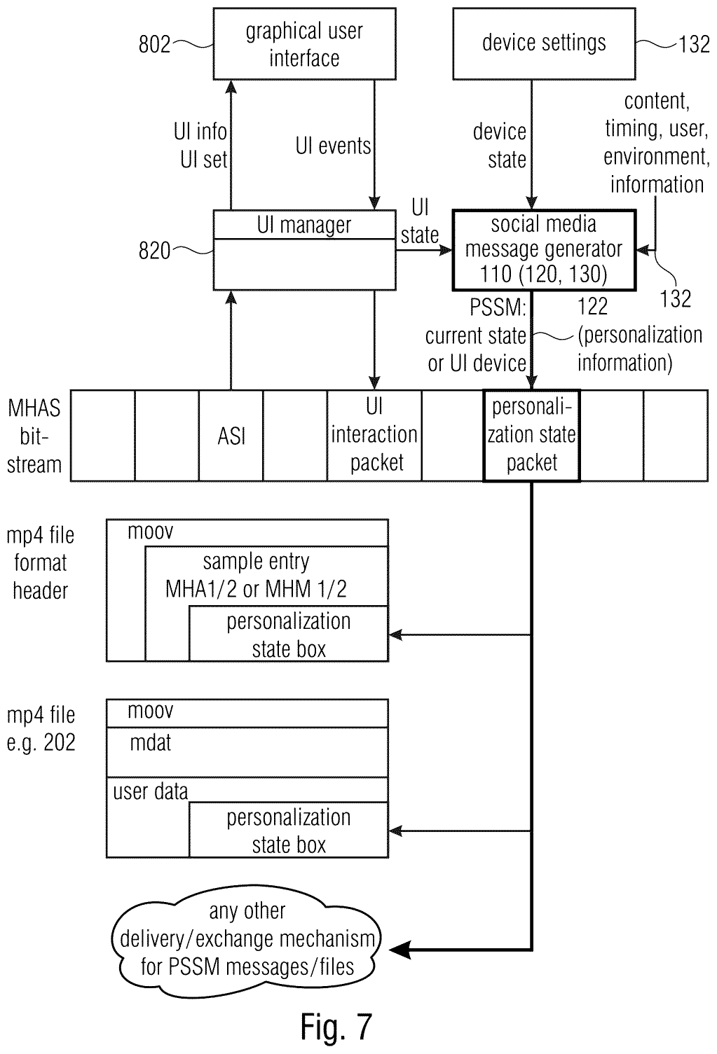

FIG. 8 shows how a Social Media Message Processor 130 (110, 129) can be embedded into a media receiver for MPEG-H 3D Audio. To apply the settings that are stored in the PSMM packet, a UI interaction packet is created and inserted into the bitstream. The UI interaction packets contains change requests to completely recreate the state as captured in the PSMM. The decoder applies the change requests from the UI interaction packet during decoding/rendering and thus the audio output is changed accordingly. At the same time, the UI manager 820 updates the UI state 149, so that the receiver can update the GUI to visualize the new personalization settings and to inform the user of the automatically applied changes.

### Data Structures

### Structure and Description of SMCM

A socialMediaControlData( ) structure or message (SMCM) may comprise (e.g. consist of) at least of the following sub-structures and attributes:

```
socialMediaControlData( )
{
  contentMediaIdentifier( )
  allowSharedExperience
  numUserCategories
  for (i=0; i< numUserCategories; i++) {
    userCategoryIdentifier
    userCategoryFeatureSet( )
  }
}
```

The contentMediaIdentifier structure may comprise (e.g. consist of) at least of the following attributes:
an (Universally Unique) Content Media Identifier to enable identification of the content to which a social media message belongs to
content genre information
content access information
content description information
personalization version tag
   Note: the same identifier is also embedded into the personalizationSocialMediaMetadata( ) described below.
   The allowSharedExperience attribute provides the indication that the current media stream allows a shared experience and based on its value, different capabilities are enabled:
No sharing capabilities allowed
Fixed sharing capabilities allowed (e.g., recommendations provided by a third-party entity/interactivity server)
Single-user sharing allowed (e.g., one user can share its personalization and invite others to experience his settings. All other users will not be able to share in the same time)
Multi-user sharing allowed in a group (e.g., Every user registers to a selected group and jointly share their settings which are than applied to the entire group)
   The numUserCategories defines the number of user categories that are defined in this control data.
   The userCategoryIdentifier attribute provides an identifier to differentiate users in different categories regarding their experience of the shared personalization settings.
   The userCategoryFeatureSet( ) data structure may comprise (e.g. consist of) a set of features and/or restrictions for a specific user category.

### Structure and Description of PSMM

A personalizationSocialMediaMetadata( ) structure or message (PSMM) may comprise (e.g. consist of) at least of the following sub-structures and attributes:

```
personalizationSocialMediaMetadata( )
{
  pssmIdentifier( )
  contentMediaIdentifier( )
  currentMediaPositionInformation( )
  contentRelatedPersonalizationData( )
  environmentDeviceRelatedPersonalizationData( )
  userRelatedInformation( )
}
```

The pssmIdentifier structure may comprise (e.g. consist of) at least of the following attributes:
unique PSMM message identifier
creator information
creation time
   The contentMediaIdentifier structure may comprise (e.g. consist of) at least of the following attributes:
an (Universally Unique) Content Media Identifier to identify the content to which the social media message belongs to
content genre information
content access information
content description information
personalization version tag
   Note: the same identifier is also embedded into the socialMediaControlData( ) described above.
   The currentMediaPositionInformation structure may comprise (e.g. consist of) at least of the following attributes:
to enable different PSMM to be applied at different positions within the content
to enable a synchronized personalized playback experience of several playback devices
   The contentRelatedPersonalizationData structure may comprise (e.g. consist of) at least of the following attributes:
the media time at which the personalization data should be applied
a media time until which the personalization data is valid (can be also implicit signaled)
codec dependent personalization data
description of the personalization
personalization version tag
   The environmentDeviceRelatedPersonalizationData may comprise (e.g. consist of) at least of the following attributes:
playback environment, resp. target loudness level or DRC settings (e.g. living room, mobile, noisy environment, full dynamic range)
preferred dialog level settings as set in the device settings
preferred language settings as set in the device settings
preferred accessibility settings (audio description, etc.) as set in the device settings
   The userRelatedInformation may comprise (e.g. consist of) at least of the following attributes:
user source of personalization information
access information, like public or closed access
recipient information, who is allowed to access it

### Structure and Description of PRM

A personalizationRecommendationMetadata( ) structure or message (PRM) may comprise (e.g. consist of) at least of the following sub-structures and attributes:

```
personalizationRecommendationMetadata( )
{
  prmIdentifier( )
  contentAndGenreIdentifier( )
  contentRelatedPersonalizationInformation( )
  listeningEnvironmentInformation( )
  playbackEnvironmentInformation( )
  deviceCapabilityInformation( )
  userGroupAndUserRelatedInformation( )
}
```

### Further Characterization of the Figures

FIG. 1: Create a PSMM during Content Playback
FIG. 2: Receive, Parse and Apply a PSMM during Content Playback
FIG. 3: Media Receiver for multi-user personalization
FIG. 4: Multi-user personalization for content distributed over broadcast/broadband connection

### FIG. 5: Timeline 1

### FIG. 6: Timeline 2

FIG. 7: Create PSSM in MPEG-H 3D Audio system
FIG. 8: Apply PSSM in MPEG-H 3D Audio system

### PSMM Data Structures Examples

Note that the examples in this section only partially implement the structures defined in the section “Data Structures”. Those examples visualise how in principle a PSMM message could be implemented in various metadata description schemes and encapsulation formats, like XML syntax, ISO/mp4 File Format box structure, and MPEG-H 3D Audio bitstream syntax. The examples don't cover all possible metadata schemes, nor are they complete representations of the defined data structures.

### XML Syntax Data Structure Examples

```
<?xml version=“1.0” encoding=“UTF-8” standalone=“yes” ?>
<PSMM>
  <uuid>bc123456-5555-4444-3333-123456789012</uuid>
  <codecType>MPEG-H Audio</codecType>
  <currentMediaTime>PT0.0S</currentMediaTime>
  <personalization>
    <startTime>PT0.0S</startTime>
    <endTime>PT45.5S</endTime>
    <personalizationData>....</personalizationData> // Contains the
codec specific personalization data (e.g. an mpegh3daElementInteraction(
) encoded as Base64)
  </personalization>
  <personalization>
    <startTime>PT45.5S </startTime>
    <endTime>PT1H30M42.42S</endTime>
    <personalizationData>....</personalizationData> // Contains the
codec specific personalization data (e.g. an mpegh3daElementInteraction(
) encoded as Base64)
  </personalization>
</PSMM>
```

### File Format Encapsulation Example

Add a new box to ISO/IEC 14496-12 on file level to ISO-BMFF for transmitting the personalization data:

### Personalization Box

### Definition

Box Type: ‘pssm’
Container: File
Mandatory: Yes
Quantity: Zero or one
   This box is used to transmit personalization data for NGA.

### Syntax

```
aligned(8) class MHAContentUUID( )
  extends Box(‘pssm’) {
  unsigned int(128) uuid;
  unsigned int(8) data[ ]; // to end of box
}
```

### Semantics

| | |
|---|---|
| uuid | The Universally Unique IDentifier to unambiguously identify |
| | the encapsulated content. |
| data | Contains the personalization data, e.g. represented as XML or |
| | binary data. |

### Bitstream Syntax Data Structure Examples Based on MPEG-H 3D Audio

Using the MPEG-H Audio system as example, a potential implementation of the bitstream packets is described below. Additional packets with similar functionality or only a subset of the functionality may be defined.
Extend Table 226 of ISO/IEC 23008-3 3th edition with a new line: “PACTYP_PERSONALIZATION_STATE”, “Value: XX”.
Extend Table 223 of ISO/IEC 23008-3 3th edition with:
case PACTYP_PERSONALIZATION_STATE:
currentStreamPosition( )
uuid;
personalisataionState( )
break;
   Add Definition and semantics of currentStreamPostion( ) and personalizationState to ISO/IEC 23008-3 3th edition:

| | | |
|---|---|---|
| currentStreamPosition( ) | | |
| { | | |
| timestamp = escapedValue(32,32,64); | 32,64,128 | uimsbf |
| timeline = escapedValue(16,16,32); | 16,16,32 | uimsbf |
| } | | |

timestamp: Signals the exact position when playback of a referenced stream/current stream was interrupted and at which play-back should continue in ticks based to the signaled timeline.
timeline: Defines the number of ticks per second.

| | | |
|---|---|---|
| personalizationState( ) | | |
| { | | |
| numPersonalizationEntries = escapedValue(8,16,32) | 8,24,56 | uimsbf |
| for (i=0; i<numPersonalization Entries; i++) { | | |
| begin = currentStreamPosition( ) | | |
| mpegh3daElementInteraction( ) | | |
| } | | |
| } | | |

numPersonalizationEnries: Shall signals the number of personalization entries.
begin: Shall signal the exact stream position when the corresponding personlisation state shall be applied.
Add Definition of uuid to ISO/IEC 23008-3 3th edition paragraph 14.3:
uuid (uimsbf, 128 bit): The Content Universally Unique IDentifier (UUID) as defined in IETF-RFC 4122 to which this PACTYP_PERSONALIZATION_STATE package belongs. The content UUID can be either be transported as part of the MHAS as described in ATSC A342 Part 3 or by the MPEG-H Audio Content UUID (as described in 20.12).
Add the following paragraphs to ISO/IEC23008-3 3th edition:

### MPEG-H Audio Content UUID

### Definition

Box Type: ‘mhaU’
Container: MHA sample entry (‘mha1’, ‘mha2’, ‘mhm1’, ‘mhm2’)
Mandatory: No
Quantity: Zero or one
Contains a Universally Unique IDentifier (UUID) as defined in IETF-RFC 4122 to unambiguously identify the encapsulated content.

### Syntax

```
aligned(8) class MHAContentUUID( )
  extends Box(‘mhaU’) {
  unsigned int(128) uuid;
}
```

### Semantics

| | |
|---|---|
| uuid | The Universally Unique IDentifier to unambiguously identify |
| | the encapsulated content. |

### OTHER EXPLANATIONS

Above, different inventive examples and aspects are described. Also, further examples are defined by the enclosed claims (examples are also in the claims). It should be noted that any example as defined by the claims can be supplemented by any of the details (features and functionalities) described in the preceding pages. Also, the examples described above can be used individually, and can also be supplemented by any of the features in another chapter, or by any feature included in the claims.

The text in round brackets and square brackets is optional, and defines further examples (further to those defined by the claims). Also, it should be noted that individual aspects described herein can be used individually or in combination. Thus, details can be added to each of said individual aspects without adding details to another one of said aspects.

It should also be noted that the present disclosure describes, explicitly or implicitly, features of a mobile communication device and of a receiver of a mobile communication system.

Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable.

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine-readable carrier. In other words, an example of method is, therefore, a computer program having a program-instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example comprises a processing unit, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following ap-pended claims be interpreted as including all such alterations, permutations and equivalents as fall within the true spirit and scope of the present invention.

1. A streaming client device, comprising:
a communication interface, to receive, from a content service provider, at least one media stream, and, from an interactivity server, personalization option metadata enabling personalization options for rendering the at least one media stream according to the personalization options;
a metadata engine, to generate personalization settings addressing the personalization options,
wherein the communication interface is configured to transmit, to at least one second streaming client device through the interactivity server, personalization metadata describing personalization settings for the at least one media stream, the streaming client device being configured to generate the personalization metadata in a file independent from the at least one audio stream.

2. A streaming client device, comprising:
a communication interface, to receive, from a content service provider, at least one media stream, the streaming client device being configured for rendering the at least one media stream according to personalization options;
a metadata engine, to generate personalization settings addressing the personalization options,
wherein the communication interface is configured to transmit, to at least one second streaming client device through an interactivity server, personalization metadata describing the personalization settings for the at least one media stream, the streaming client device being configured to generate the personalization metadata in a file independent from the at least one audio stream.

3. The streaming client device according to claim 1, configured to generate the personalization metadata according to, or at least conditioned by, the state of the streaming client device.

4. The streaming client device of claim 1, configured to generate the personalization metadata to include at least one timing information indicating a time point in the at least one media stream in which an event in a personalization session has occurred.

5. The streaming client device of claim 4, configured to define the timing information based on event(s) defined by the user through user's input(s).

6. The streaming client device of claim 1, configured to generate the personalization metadata to include at least one address identification which is a link or other information on how to find out the at least one stream and/or an identifier associated to the at least one media stream.

7. The streaming client device of claim 1, configured to generate the personalization metadata, or another communication message, to include at least one authorization information, indicating a level of restriction of the at least one media stream which subscriber or streaming client device, or class of subscribers or streaming client devices, is admitted to receive the personalization metadata.

8. The streaming client device of claim 1, configured to transmit, to the interactivity server, the personalization metadata towards at least one second streaming client device, so as to set the second streaming client device according to the personalization metadata.

9. The streaming client device of claim 1, configured to:
receive the at least one media stream from the content service provider, that is received synchronously by at least one second streaming client device,
in parallel, transmit, through the interactivity server, to the at least one second streaming client device, personalization metadata associated with already provided portions of the at least one media stream.

10. The streaming client device of claim 1, configured to parse the personalization option metadata, or another message transmitted from another streaming client device, to retrieve information on at least one state of the other streaming client device, so as to apply the at least one state, completely or partially, to the streaming client device.

11. The streaming client device of claim 1, configured to:
receive the at least one media stream synchronously to the second streaming client device,
in parallel, receive, through the interactivity server from the second streaming client device, personalization option metadata associated with already provided portions of the at least one media stream, the personalization option metadata being associated with portions of the at least one media stream,
wherein the metadata engine is configured to apply the personalization settings obtained from the personalization metadata,
wherein the metadata engine is configured for generating new personalization metadata,
wherein the streaming client device is configured to transmit, through the interactivity server, to the second streaming client device, the new personalization metadata with timing information providing information on when, in the at least one media stream, the new personalization metadata are to be applied.

12. The streaming client device of claim 1, wherein the personalization metadata include at least one of preferred dialog level settings, preferred language settings, and preferred accessibility settings.

13. The streaming client device of claim 1, wherein:
the communication interface is configured to request to, and receive, through the interactivity server from a second streaming client device, further personalization metadata generated by the second streaming client device and describing personalization settings for the at least one media stream,
wherein the metadata engine is configured to apply the personalization settings, obtained from the further personalization metadata, to personalization options, so as to provide to a decoder, or a transcoder, the at least one media stream with the personalization settings.

14. A streaming client device comprising:
a communication interface to receive, from a content service provider, at least one media stream, wherein the communication interface is configured to request to, and/or receive from a second streaming client device through an interactivity server, personalization metadata describing personalization settings for the at least one media stream, the personalization metadata being in a file independent from the at least one media stream,
a metadata engine, configured to apply personalization settings, obtained from the personalization metadata, to personalization options, so as to provide to a decoder, or a transcoder, the at least one media stream with the personalization settings.

15. The streaming client device of claim 14, configured to parse the personalization metadata, or another message transmitted from another streaming client device, to retrieve information on at least one state of the other streaming client device, so as to apply the at least one state, completely or partially, to the streaming client device.

16. The streaming client device of claim 14, configured to:
receive the at least one media stream synchronously to the second streaming client device,
in parallel, receive, through the interactivity server from the second streaming client device, personalization option metadata associated with already provided portions of the at least one media stream, the personalization option metadata being associated with portions of the at least one media stream,
wherein the metadata engine is configured to apply the personalization settings obtained from the personalization metadata,
wherein the metadata engine is configured for generating new personalization metadata,
wherein the streaming client device is configured to transmit, through the interactivity server, to the second streaming client device, the new personalization metadata with timing information providing information on when, in the at least one media stream, the new personalization metadata are to be applied.

17. The streaming client device of claim 14, wherein the metadata engine is configured to modify the personalization settings obtained from the personalization metadata to generate subsequent personalization settings addressing subsequent personalization options and/or personalization settings,
wherein the communication interface is configured to transmit, through the interactivity server to the second streaming client device, subsequent personalization metadata describing subsequent personalization settings of the at least one media stream.

18. The streaming client device of claim 14, configured to generate new personalization metadata from second personalization settings, and send the new personalization metadata through the interactivity server to the second streaming client device.

19. The streaming client device of claim 14, configured to extract the personalization settings from the personalization metadata and to perform an evaluation on whether the personalization settings match the capabilities of the streaming client device and, in case of positive result of the evaluation, the personalization settings are actually applied, and, in case of negative result of the evaluation, the personalization settings are not applied and/or an evaluation non-acknowledgement is sent through the interactivity server to the second streaming client device.

20. The streaming client device of claim 1, wherein the media system used for enabling a shared multi-device and multi-user personalized experience is MPEG-H 3D Audio.

21. A streaming server system comprising:
a repository, to store, in association with a plurality of media streams, personalization option metadata enabling personalization options for rendering the at least one media stream according to the personalization options;
a communication interface, configured to:
transmit, to a first streaming client device, personalization option metadata enabling personalization options for rendering the at least one media stream according to the personalization options;
receive, from the first streaming client device, personalization metadata describing personalization settings addressing the personalization options, so that the personalization metadata are stored in the repository in association with the at least one media stream, the personalization metadata being in files independent from the at least one media stream;
transmit, to the at least one second streaming client device, the personalization metadata.

22. A method for enabling a shared personalized experience amongst multiple media receiving devices, the method comprising:
sending a media stream which contains metadata that enable individual personalization options for each user on a media receiving device;
receiving the media stream by at least two independent media receiving devices;
at least one user interacting with the media content on at least one first media receiving device and applying his preferred personalization options to the content on the at least one first media receiving device;
sharing media content specific and personalized settings from the at least one first media receiving device to the at least one second media receiving device, such that the at least one second media receiving device receives at least the media content, a content identifier, the personalization settings, synchronization and/or timing information describing the time of each personalization setting change and control and/or personalization metadata describing the allowed interactivity and/or personalization settings;
wherein the at least one second media receiving device applies the personalization settings associated with the media content and the personalization settings created on the one first media receiving device using the received synchronization and/or timing information.

23. The method of claim 22, configured to parse the personalization metadata, or another message transmitted from another streaming client device, to retrieve information on at least one state of the other streaming client device, so as to apply the at least one state, completely or partially, to a receiving device.
